(19) United States
(12) Patent Application Publication
(10) Pub. No.: US 2018/0049410 A1
(43) Pub. Date: Feb. 22, 2018

(54) Ephemeral Substrates for Oyster Aquaculture

(71) Applicant: The University of North Carolina at Chapel Hill, Chapel Hill, NC (US)

(72) Inventors: Niels Lindquist, Morehead City, NC (US); David Cessna, Smyrna, NC (US)

(21) Appl. No.: 15/556,233

(22) PCT Filed: Mar. 4, 2016
(86) PCT No.: PCT/US2016/020966

§ 371 Date: Sep. 6, 2017

Related U.S. Application Data
(60) Provisional application No. 62/129,563, filed on Mar. 6, 2015.

(51) Int. Cl. A01K 61/70; E02B 3/04

(52) U.S. Cl. CPC A01K 61/70; E02B 3/046

(57) ABSTRACT

Provided is novel ephemeral substrate material for growing oysters that alleviates concerns related to adding large quantities of permanent fill to estuarine water and promotes high rates of oyster survival and growth, high meat quality and market-favorable shell-shape of cultured oysters, along with artificial oyster growing structures prepared from the ephemeral substrate material and methods of using the same.

### RELATED APPLICATIONS

The present application claims the benefit, under 35 U.S.C. §119(e), of U.S. Provisional Application No. 62/129,563, filed Mar. 6, 2015, the content of which is incorporated by reference herein in its entirety.

### BACKGROUND OF THE INVENTION

Oysters are truly unique. They are the only animal that people consume in great quantities that also create the structural foundations of exceptionally productive ecosystems. Sadly, centuries of over-harvest and coastal development have decimated once extensive oyster reefs and habitat, thereby degrading coastal communities and economies as the vast array of beneficial goods and services oysters provide has waned (Beck et al. 2011). Tremendous efforts have gone into restoring oyster habitats in U.S. estuaries. Despite nearly two decades of oyster sanctuary construction and many more years of cultch planting, oyster harvesting throughout the country has failed to recover since bottoming out nearly 30 years ago.

Failure to appreciate the role played by salinity in oyster biology has, in part, contributed to the lack of success. Salinity is the fundamental environmental parameter controlling the distribution of estuarine species, and, importantly, the condition and resilience of oysters. Oysters survive and thrive in two “safe zones” in estuarine environments: (1) intertidal zones in higher salinity waters near coastal inlets and (2) lower salinity portions of estuaries (Winslow 1889, Grave 1904, Fodrie et al. 2014, Rodriquez et al. 2014, Ridge et al. 2015). Oysters have exceptional tolerance of environmental stressors, such as tidal-driven aerial exposure and freshets, whereas their pests—predators, competitors, parasites, etc.—are much less tolerant. Outside of these safe zones, settling oysters are at high risk of death and reef creation stalls. This important generalization has been known for centuries and underpinned historic oyster cultivation practices (Dean 1892).

Unfortunately, old wisdom about oyster ecology is not always incorporated into modern oyster management, restoration and mariculture practices. Recent efforts on these fronts have often embraced untested or poorly-tested assumptions about factors controlling oyster survival and growth while making decisions about where and how to restore oyster populations and site aquaculture operations. Importantly, siting mistakes can in fact be detrimental to oyster populations, as many permanent fill materials that fail to sustain vibrant oyster communities will be colonized by a plethora of oyster pests that will likely disperse to and compromise the viability of nearby regions that do support oysters.

Oysters typically grow attached to hard substrates, including the shells of other oysters and hard structures that humans add to estuarine environments, such as seawalls and jetties. Oyster shell, rocks of various types, and concrete structures and rubble are also planted on submerged estuarine bottoms to create the foundations of oyster habitat for aquaculture, rehabilitation of public oyster beds and oyster sanctuaries. Oyster recruitment can be highly variable, but when oysters settle at very high density, the densely-packed oysters grow long and thin (an oyster shape with a poor market value), and because of intense competition with neighboring oysters for water-borne foods, these oysters often have poor meat quality and increasing rates of oyster mortality within the population. Further, government regulations may restrict where hard substrates (“fill” in the eye of coastal management groups) can be deployed in estuarine waters and, where it is allowed, the fill footprint and its height above the bottom are tightly limited. Improved substrates that overcome the shortcomings of the prior art are needed.

### SUMMARY OF THE INVENTION

To overcome issues related to oyster crowding on substrates and concerns about fill materials added to estuarine waters, an ephemeral substrate, which serves as cultch that is conducive to oyster settlement and that will breakdown into small pieces over time has been developed. With the breakdown of the substrate there should be no concerns about adding permanent fill to estuarine waters, and, as the substrate decomposes, oysters initially growing together on the substrate become separated allowing them to grow a more favorable shape for marketing and improving meat quality and having higher rates of oyster survival and growth. Further, the ephemeral substrate is not conducive to colonization by some highly detrimental oyster pests, and its lack of persistence ensures it will not promote oyster pest populations in general if an oyster community fails to persist.

In accordance with the present invention, provided is an ephemeral substrate material for growing oysters. The ephemeral substrate material may comprise a biodegradable fiber and a binder comprising a mineral-based hardening agent. In a further aspect of the invention, provided is an artificial oyster growing structure comprising the ephemeral substrate material.

In another aspect of the invention, provided is a method for cultivating oysters comprising the use of an artificial oyster growing structure comprising the ephemeral substrate material. In yet another aspect of the invention, provided is a method of transferring oysters to a location of lower oyster abundance or reintroducing oysters to a location, comprising the use of an artificial oyster growing structure comprising the ephemeral substrate material.

In yet another aspect of the invention, provided is a method of creating a message or advertisement comprising the use of an array of artificial oyster growing structures comprising the ephemeral substrate material as set forth herein.

In yet another aspect of the invention, provided is a method of controlling shoreline erosion comprising the use of an artificial oyster growing structure or an array of artificial oyster growing structures comprising the ephemeral substrate material as set forth herein to create oyster reefs for erosion control.

In yet another aspect of the invention, provided is a method of developing a saltmarsh habitat comprising the use of an artificial oyster growing structure or an array of artificial oyster growing structures comprising the ephemeral substrate material as set forth herein to create oyster reefs suitable for saltmarsh colonization.

### BRIEF DESCRIPTION OF THE DRAWINGS

FIG. 1. Panel A—View of various modular oyster growing structure components drying after burlap cloth was infused with a 1:1 by weight cement-water mixture. Panel B—View of support stakes created by twisting a 7-oz burlap cloth impregnated with a cement-water mixture. These 1 m stakes are cut in half to produce 0.5 m long stakes. Panel C—View of 2 m long oyster growing structure cross-members made from twisting burlap erosion control cloth. Panel D—View of flat oyster growing structure panels created from jute erosion control cloth.

FIG. 2. Panel A—Setting of oyster growing structure support stakes. Panel B—Cross-members attached to support stakes. Panel C—Panels attached to cross-members. Panel D—Close-up of completed oyster growing structure. Panel E—Side view of completed oyster growing structures showing open space beneath the oyster growing structure. Panel F—Constructed oyster growing structures at high tide 18 hours post construction. Panel G—Constructed reef at low tide 24 hours post construction. Panel H—View of cement impregnated jute twine used to tie oyster growing structure elements together.

FIG. 3. Left panel—view of a newly constructed 2 m×2 m×0.25 m modular oyster growing structure. Right panel—view of a modular oyster growing structure cross-member showing the exceptionally high oyster densities that can be attained when reef components are properly positioned in the intertidal zone.

FIG. 4. Top down view of an exemplary 4 m×4 m artificial oyster growing structure prepared from the ephemeral substrate material of the invention.

FIG. 5. Panel A—Edge view of an exemplary 4 m×4 m artificial oyster growing structure prepared from the ephemeral substrate material of the invention set on a surface. Panel B—Edge view of another exemplary 4 m×4 m artificial oyster growing structure prepared from the ephemeral substrate material of the invention set on a surface.

FIG. 6. Depiction of individual, oyster-coated posts (light shading) inserted into estuarine bottom behind a wave/tide shield created from oyster-coated support posts and horizontal connecting rods (dark shading). All elements were transferred with attached oysters from a region of high oyster larval settlement after a period of oyster growth. Mean water level for this site would be at least at the top of the oysters coated posts or higher.

FIG. 7. Depiction of oyster coated posts transferred with attached oysters from a region of high oyster larval settlement after a period of oyster growth and inserted into the sediment at the base of a seawall in an area of low oyster abundance. Mean water level for this site would be at least at the top of the oysters coated posts or higher.

FIG. 8. Overhead view of the shellfish lease in Google Earth. The boat in this view is 22 feet long.

FIG. 9. Legend for materials deployed on the shellfish lease.

FIG. 10. Views of the rod and rasta reef framework for supporting layered panels. Top image shows the framework prior to the attachment of panels and before oyster larval settlement commenced. Bottom images show oyster-coated rods and rastas ˜4-month after the initial pulse of oyster larval settlement.

FIG. 11. Views of rasta bundles not used in reef framework building. Bundles of rods and rastas were separated and laid out on racks for continued oyster recruitment and growth. Oyster-coated rods and rastas can be used in reef construction at off-lease locations.

FIG. 12. Views of panels deployed on the shellfish lease. Top image shows layers of panels, 2-3 panels thick, attached to a reef framework created from rods and rastas. Bottom images show oysters growing on the panels ˜4 months after the initial pulse of oyster larval settlement.

FIG. 13. Views of stacked oyster patties prior to oyster recruitment (top image) and of oyster patties ˜4 month after the initial pulse of oyster larval settlement.

FIG. 14. Views of the panel material with attached oysters prior to and after the shedding process (top images). The middle images show three different size-classes of shed oysters. The bottom image show mesh bags containing shed oysters wired to a rebar rack on the Newport River lease.

FIG. 15. Top images show steps in the manufacture of panels, and in this instance panels infused with a colored cement binder. Bottom right image shows newly deployed colored panels on the lease site. Bottom left images image show a shed oyster with colored binder imbedded in its shell and an oyster with an indentation of a fiber cloth bundle in its shell.

FIG. 16. Top images provide views of rod bundles arrange to form the abbreviation for the United State of America and colored panels in a variant of the U.S. flag. In the lower image, rod bundles formed abbreviations for the UNC Institute of Marine Sciences and Office of Technology Development.

FIG. 17. Views of the oyster reef framework created from the ephemeral substrate along the shoreline of the IMS campus. Top left image shows the initial framework created in January. Oysters recruited to the framework during the summer of the same year. Additional framework of seeded rods and rastas was added in the fall of the same year (top right). The lower left image is a close up of the dense oyster community on the reef after ˜6 months of oyster growth. The bottom right image shows sediment accumulation behind the reef as of January of the following year.

FIG. 18. Views of the relative positions of the two rows of oyster shell reefs deployed off the IMS campus shoreline in May. Images show the condition of the reefs in June after one month (top), February of the next year after nine months (middle) and January, after twenty months (bottom).

FIG. 19. Views of oyster shell bags around Jones Island in the White Oak River near Swansboro, N.C. Top image show stacked bags creating a reef foundation. The middle and bottom images show deteriorating plastic mesh bags lacking live oyster cover.

### DETAILED DESCRIPTION

In the following detailed description, embodiments of the present invention are described in detail to enable practice of the invention. Although the invention is described with reference to these specific embodiments, it should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. The invention includes numerous alternatives, modifications, and equivalents as will become apparent from consideration of the following detailed description.

It will be understood that although the terms “first,” “second,” “third,” “a),” “b),” and “c),” etc. may be used herein to describe various elements of the invention should not be limited by these terms. These terms are only used to distinguish one element of the invention from another. Thus, a first element discussed below could be termed a second element aspect, and similarly, a third without departing from the teachings of the present invention. Thus, the terms “first,” “second,” “third,” “a),” “b),” and “c),” etc. are not intended to necessarily convey a sequence or other hierarchy to the associated elements but are used for identification purposes only. The sequence of operations (or steps) is not limited to the order presented in the claims or figures unless specifically indicated otherwise. Steps may be conducted simultaneously.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP §2111.03. Thus, the term “consisting essentially of” as used herein should not be interpreted as equivalent to “comprising.”

The term “about,” as used herein when referring to a measurable value, such as, for example, an amount or concentration and the like, is meant to encompass variations of ±20%, ±10%, ±5%, ±1%, +0.5%, or even ±0.1% of the specified amount. A range provided herein for a measureable value may include any other range and/or individual value therein.

In some embodiments, provided by the invention is a material suitable for the preparation of ephemeral substrates, which as will be appreciated by one of skill in the art to be suitable for growing mollusks thereon, more particularly oysters, which substrate will break down into small pieces over time. As the substrate breaks down over time, oysters initially growing together on the substrate become separated allowing the oysters to grow in a more favorable shape and also providing improved meat quality of the oysters and having higher rates of oyster survival and growth.

In some other embodiments, the ephemeral substrate material provided by the invention comprises a biodegradable material and a binder comprising a mineral-based hardening agent. Any suitable biodegradable material or binder as would be appreciated by one of skill in the art may be used in the ephemeral substrate material of the invention to provide the characteristics desired, for example, the initial resilience of the ephemeral substrate material and/or rate at which the ephemeral substrate material breaks down. Such may be achieved by, for example, but not limited to, varying the percentage of biodegradable material and binder in the ephemeral substrate material.

In some embodiments, the biodegradable material of the ephemeral substrate material is a natural plant material. The natural plant material may be processed, for example, woven to provide a fiber. The natural plant material or natural plant fiber may be a cellulose/lignin-based product of low nitrogen content. The natural plant material or natural plant fiber may be, but is not limited to, for example, any one of the group consisting of burlap, jute, sisal, hemp, bamboo and palm leaf, or any combination of one or more thereof. In some embodiments, the natural plant material or natural plant fiber may be jute or sisal. In some other embodiments, the natural plant material or natural plant fiber may then be used to provide a woven fabric, for example a cloth. The woven fabric may be, for example, but not limited to, burlap or hessian, or gunny cloth. The woven fabric may, in some embodiments, be a coarse or dense woven fabric, which, for example, burlap or hessian traditionally has been produced. In some other embodiments, more refined preparations of the woven fabric may be used, which, as one of skill in the art will appreciate, is known simply as jute. The size and shapes of the woven fabric are not particularly limited. Cloths, fibers and fabrics used may be cut down from larger pieces of cloth, fibers and fabric to desired sizes and/or shapes. In some embodiments, the woven fabric may be provided as burlap/jute in long bolts of about 3 feet to about 4 feet in width, or as jute erosion control cloth (JECC) and the like.

In other embodiments, the binder of the ephemeral substrate material of the invention is cement or cement-based, including but not limited to hydraulic cements, non-hydraulic cements, mortars and concretes. In some embodiments, the cement binder of the ephemeral substrate material may be, but is not limited to, hydraulic cement or mixtures of hydraulic and non-hydraulic cement. The cement may comprise further components, including, but not limited to, activated aluminum silicates and pozzolanas, such as fly ash. In an embodiment, the hydraulic cement is Portland cement. The Portland cement may be grey Portland cement or white Portland cement, or may include a mixture of grey and white Portland cements. In some embodiments, the cement of the binder may be formulated to be lower in heavy metal content in the binder. In other embodiments, the binder may contain a mixture of cements, a mixture of cement and additives, and/or a mixture of cements and additives. Further examples of additives to the binder include, but are not limited to, calcium aluminate and inorganic sulfate. In some embodiments, the additive may be hydrated lime, i.e., calcium hydroxide (Ca(OH)₂. In still other embodiments, the binder may be produced by calcium carbonate depositing microorganisms, for example, bioMASON®.

In some other embodiments, the ephemeral substrate material may be used in combination with longer lasting materials. For example, the ephemeral substrate material may be used in combination with, for example, but not limited to, longer lasting materials, such as steel rebar or PVC. These longer lasting materials may be used, for example, in some instances, to form frameworks to more securely hold structural variations of the ephemeral substrates, such as panels and bundles of linear structural types, at optimal spacing during oyster settlement and early growth periods.

The arrangements and/or spacing of the various pieces, shapes and components used to prepare an artificial oyster growing structure are also variable and not particularly limited. In some embodiments, the various pieces, shapes and components comprising the ephemeral substrate material described herein are arranged and/or spaced in a manner so as to maximize oyster larval settlement and early juvenile survival. In some embodiments, close spacing of the various different pieces, shape and components comprising the ephemeral substrate material may be less than about 50 cm, for example, less than about 40, 30, 20 or less than about 10 cm, or about 5 cm between pieces, shapes and components. In some embodiments, the spacing may be about 1-50 cm, 1-40 cm 1-30 cm, 1-20 cm, or about 1-10 cm between and/or among the different pieces, shapes and components to enhance oyster larval settlement and juvenile oyster survival.

Small confined spaces provide refuge for small oysters from many types of biological stressors, predators in particular. Close spacing, for example, between deployed pieces of ephemeral substrates, as discussed above, enhance the survival of juvenile oysters, and in a likely feedback process, increases levels of chemical signals that encourages more oyster larvae to settle. Examples of deployed materials with tight spacing between different pieces include bundles of linear element like rods (for example, 10 per bundle) and stacks (for example, 2-3 stacked panels) of closely spaced panel-like substrates. In some embodiments, 1-m² panels comprising the ephemeral substrate material provide densities of about 5000 oysters per panel. Stacked panels have the capability to settle oysters at tremendously high densities per area of intertidal bottom.

The rate at which the ephemeral substrate material breaks down will be dependent upon the characteristics desired for the substrate and purpose for which the substrate will be used. The rate of breakdown may vary from about 2 months to about 24 months, depending upon the desired purpose of the ephemeral substrate material. For example, in some embodiments, ephemeral substrates prepared to have a longer life span, such as about 12 months to about 24 months, will produce more physically resilient oyster growing structures suitable for the restoration of oyster habitats and reef building along shorelines for erosion control. In other embodiments, ephemeral substrates prepared to last about 4 months to about 8 months are suitable for catching oyster spat that will then shed juvenile oysters as single and small clusters as the ephemeral substrate material disintegrates and biodegrades, which permit the oysters, freed of forced crowded conditions, to develop a more preferred and more market favorable rounded, deep-cupped shell morphology. The breakdown characteristics of the ephemeral substrate material may be varied by, for example, altering the weight ratio of biodegradable fiber or cloth to binder, wherein a greater ratio of binder to biodegradable fiber results in substrates with a longer life span, using different binders, such as cement with differing levels of additives, such as pozzolanas, by using mixtures of hydraulic and non-hydraulic cements, and/or by varying the different characteristics, weaves and/or shapes of the biodegradable fiber or cloth.

In addition, estuarine water chemistry plays a role in the lifetime of the ephemeral substrate materials as set forth herein. In water of higher salinity and/or pH, characteristic of intertidal habitats near coastal inlets, the longevity of, for example, set Portland cement is substantially greater than the same material transferred to or exposed to water of lower salinity and/or pH. Sea water typically has a salinity of about 35 practical salinity units. Estuarine waters are typically quite variable, and the salinity of estuarine waters may vary between about 0.5 to about 30 practical salinity units. Thus, in some embodiments, the lifetime of the ephemeral substrate material of the invention is determined in salt water or sea water, for example, water with a salinity of about 35 practical salinity units. In other embodiments, the lifetime of the ephemeral substrate material of the invention is measured under conditions more typically found in estuarine environments, for example, water with a salinity of about 20 practical salinity units. In yet other embodiments, the lifetime of the ephemeral substrate material of the invention is determined in water with a salinity of less than 20 practical salinity units, or even in water with a salinity of about 0-0.5 salinity units, such as fresh water.

The ephemeral substrate material of the invention may be prepared by soaking the biodegradable fiber or cloth, for example, burlap or jute, in wet cement or a cement/water mixture. In some embodiments, the cement/water mixture is in the range of about 1:2 to about 3:1 ratio by weight, for example, but not limited to, about a 1:1 ratio by weight cement/water mixture or about a 2:1 ratio by weight. In some embodiments, the biodegradable fiber is impregnated with the binder in the range of about 1:10 to about 3:4 ratio by weight of biodegradable fiber to dried, hardened binder. In other embodiments, the biodegradable fiber is impregnated with the binder in the range of about 1:8 to about 1:2 ratio by weight of biodegradable fiber to dried, hardened binder, or any ratio in between. For example, the biodegradable fiber is impregnated with the binder at about a 1:8, 1:7, 1:6, 1:5, 1:4, 1:3, or about a 1:2 ratio by weight of biodegradable fiber to dried, hardened binder. The biodegradable fiber or cloth may either be left thoroughly infused with cement, or a substantial portion of the cement may be squeezed from the biodegradable fiber, and while still wet, forming the cement infused fiber or cloth into various shapes. These shapes include, but are not limited to, in some embodiments, components such as posts, cross-members and rods in which the cement infused biodegradable fiber or cloth is rolled and/or twisted, flat panels, corrugated panels, sheets, strands, mounds and the like. When dried, these components may have great initial physical resilience. The surface area to volume ratio of the biodegradable fiber impregnated with the binder is not particularly limited, but should be sufficient for the ephemeral substrate material to initially maintain structural integrity and/or support other components within a structure comprising components prepared from the ephemeral substrate material as set forth herein.

In some embodiments, twisting of cloth wetted with binder adds additional structural rigidity to the cured component. For example, twisted pieces of cloth wetted with binder may be used to prepare rods of about 1-m in length and about 2-4 cm in diameter. Such structures may have a relatively smooth surface. In other embodiments, pieces of cloth, for example, jute erosion control cloth (JECC) may be used to prepare cylindrical elements with a complex rugose or rough surface that resemble dreadlocks, or “rastas” as described herein. Rastas may be, for example, cylindrical structures that are about 1.25-m long and about 3-5 cm in diameter that may be provided to act as cross-members for reef frameworks.

In other embodiments, scrap fibers and shards of JECC and wetted cement remaining after a session of preparing panels, rods or rastas may be formed into structures called “patties.” Patties may have a round, somewhat flattened shape with a 3-5 cm diameter hole in the center, much like a doughnut. By using waste JECC and other plant fiber and cloth remnants and cement to make patties, manufacturing waste can be eliminated.

In yet other embodiments, the ephemeral substrate material provided and formed into various shapes or components may be used to prepare an artificial oyster growing structure, which includes, in a non-limiting example, artificial reefs for growing oysters. In some embodiments, the shapes or components may be assembled and arranged to provide an artificial oyster growing structure or reef that is highly conducive to oyster larval settlement. In other embodiments, portions of the artificial oyster growing structure are supported at an elevation off a surface, for example, in an intertidal zone, on a sand flat, mud flat or the like, on which the artificial oyster growing structure is provided for growing oysters. In some embodiments, portions of the artificial oyster growing structure are supported at least about 10 cm off, about 20 cm off, about 30 cm off, about 40 cm off, about 50 cm off or any measurement in between, off the surface on which the artificial oyster growing structure is provided. In other embodiments, the artificial oyster growing structure is suspended or supported in the water column 50 cm or more off the sediment surface. In some other embodiments, portions of the artificial oyster growing structure are secured directly on the surface on which the artificial oyster growing structure is provided.

The size and shape of the artificial oyster growing structure is variable and not particularly limited. Non-limiting examples of sizes and shapes of the artificial oyster growing structure include 1 m×4 m, 2 m×2 m and 4 m×4 m structures. Multiple possible combinations of one, two and three dimensional architectural elements comprising the ephemeral substrate material may be arranged to form the artificial oyster growing structure.

In some embodiments, the size and shape of the oyster growing structure is variable through multiple possible combinations of one, two or three dimensional elements attached on top of cross-member rods attached to upright support posts partially buried in the sediment on the surface on which the artificial oyster growing structure is provided or constructed.

In some embodiments, these oyster growing structures may comprise rods or rastas, and may also comprise panels, which may be attached to a reef framework created from rods and/or rastas. In other embodiments, the oyster growing structures may comprise patties. The patties may be stacked, and deployed in stacks of about 3, 4 or 5 patties.

The artificial oyster growing structures may be constructed with shapes and components prepared from the ephemeral substrate material as set forth herein with breakdown characteristics depending upon the desired purpose for the artificial oyster growing structure. The rate of breakdown of the artificial oyster growing structures may be similar in range to the breakdown of the ephemeral substrate material described herein, for example, about 2 months to about 24 months, and in some embodiments, from about 4 months to about 8 months, from about 6 months to about 12 months, or from about 12 months to 24 months. The various shapes and components of the artificial oyster growing structure may be prepared to break down at different rates. In some embodiments, interior flat or corrugated panels and sheets may be prepared to break down more rapidly, for example, in 4-6 or 4-8 months, suitable for catching oyster spat, then shedding juvenile oysters as single or small clusters, whereas border and support elements, such as rods, posts and cross-members, may be prepared to be more resilient to breakdown and have longer lifetimes.

In other embodiments, the artificial oyster growing structures may be deployed either individually, or as an array comprising a plurality of artificial oyster growing structures. In that the shape and size of the artificial oyster growing structures are not particularly limited, in some embodiments, the array of a plurality of the artificial oyster growing structures may be arranged to form letters, numbers, logos and/or shapes and the like, which may be easily identifiable from an altitude above the ground if, for example, during a normal tidal cycle, the array is exposed to air. The arrangement of the array of artificial oyster growing structures may be used, for example, to create either a message or advertisement. In yet other embodiments, the ephemeral substrate material my further comprise materials that provide a color, for example, colored small durable particulates or other durable materials, such as, but not limited to, colored particles, colored sands, particulate or chemical materials that may be fluorescent and the like, for example, colored sands, which may assist in identification of and/or visibility of the artificial oyster growing structures. The colored particles or other durable materials (particulate or chemical) may also be useful for identifying and tracking of oysters shed from the ephemeral substrate structures as solid or chemical binder components will be incorporated into the shells of oysters attached to any reef substructure composed of the ephemeral substrate described herein.

Thus, in some embodiments, the identifying features that may be used in tracking of oysters shed from the ephemeral substrate structures may include an embedded chip of the cement-based binder and/or an indentation of a fiber-bundle. While not all oysters shed from these ephemeral substrates will have these unique identifying features, a substantial portion of them will. Furthermore, during substrate manufacturing, a variety of potential markers can be added to the wetted binder, including dyes, colored particles and the like as described above, or other materials visible to the eye or not, before it is infused into the fiber bundles of the cloths. Cement dyes and other dying agents may be used to color a portion of the panels. The colors produced included, for example, pink, red and blue. Even without coloring, the presence of binder embedded in the shell can point to the origin/source of an oyster. With or without coloring the binder, a substantial number of oysters shed from the substrates as described herein possess a tubular indentation in their left valve as they grow around a hardened fiber bundle. Once dislodged from the substrate, shell trenching remains as oysters do not add new shell material to the former substrate attachment point as they grow. This anti-theft feature is unique to the substrate system as set forth herein, and provides a further method of identifying the origin/source of an oyster.

The location of where the artificial oyster growing structures as set forth herein are provided is not particularly limited. In some embodiments, the artificial oyster growing structures are provided in, for example, but not limited to, a coastal or estuarine water body. In still other embodiments, the structure is provided in an intertidal zone of the coastal or estuarine water body. Intertidal zones in many coastal water bodies are replete with oyster larvae during the reproductive season of oysters yielding high oyster larval settlement rates on the ephemeral substrates. In some other embodiments, the structure is provided in estuarine waters or a water body with an average salt content of 35 practical salinity units or less. In still other embodiments, the structure is provided in estuarine waters or a water body with an average salt content of 20 practical salinity units or less. In still further embodiments, at least a portion of the structure or the entire structure is exposed to air on each normal tide cycle. In still other embodiments, at least a portion of the structure or the entire structure is exposed to air about 10% to about 50% of the time, for example, about 10%, about 15%, about 20%, about 25%, about 30%, about 35%, about 40%, about 45% or about 50% of the time, or any percentage in between, on each normal tide cycle.

Estuarine zones that experience astronomically driven tides of about 0.5 m and greater most often support large populations of intertidal oysters along shorelines and on vertical hard structures due to the relatively more consistent environmental conditions, primarily salinity and water temperatures, driven by tidal influxes of oceanic waters. These conditions promote successful oyster spawning and high oyster larval abundances in these waters. In contrast, in estuarine zones where environmental conditions are more variable, for example in zones closer to the headwaters of estuaries, the spawning success of oysters can be reduced as can be the delivery of oyster larvae to these areas where the bulk transport of waters is down the estuary toward the ocean. Oyster larval settlement rates are more variable in such areas, and during some years no oyster larvae may settle even though healthy and viable oyster populations exist there. In some areas, few to no oysters may exist simply because transport of oyster larvae by water currents to those areas rarely occurs, despite the area having environmental conditions that would support the growth of oysters and persistence of oyster-based habitats.

In still other embodiments, the artificial oyster growing structures as set forth herein may be prepared so that the artificial oyster growing structures may be moved from a first location to another to move and/or provide oysters at the second location. For example, in some embodiments, the artificial oyster growing structures may be used in providing oysters to a location of low oyster population or lower oyster abundance, or in providing oysters to a location in which oysters are to be reintroduced and/or cultivated, for example but not limited to, construction of shoreline reefs for erosion control and estuarine habitat creation. The artificial oyster growing structures may be seeded with juvenile oysters by providing the artificial oyster growing structure or structures in, for example, an intertidal zone of a body of water, such as in a coastal or estuarine water body with high oyster larval settlement rates for a specified period of time. This period of time may be dependent on the desired number of or density of oysters, or the age and/or size of the oysters that are to be moved. This period of time may be as short as about two months, or as long as about 12 months, or any time duration in between. In some embodiments, the seeding of the artificial oyster growing structure takes place where at least a portion of the artificial oyster growing structure is exposed to air on each normal tide cycle. In further embodiments, the portion of the artificial oyster growing structure is exposed to air for about 10% to about 50%, for example, about 10%, about 15%, about 20%, about 25%, about 30%, about 35%, about 40%, about 45% or about 50% of the time, or any percentage in between, of the time on each normal tide cycle.

Although the location with a low oyster population is not particularly limited, in some embodiments, the location with a low oyster abundance to which the structures previously seeded are moved to has a lower salinity and/or pH relative to where seeding of the artificial oyster growing structures takes place. In some embodiments, the location to which the structures are moved to has an average salt content of 20 practical salinity units or less. In some embodiments, the location of low oyster population is a subtidal region of a body of water. In still other embodiments, seeding of the artificial oyster growing structure takes place in, for example, a laboratory oyster hatchery or an oyster hatchery facility.

In yet other embodiments, the artificial oyster growing substrates and structures prepared from the same as set forth herein may be used to rehabilitate or repopulate an oyster bed. In further embodiments, the artificial oyster growing substrates and structures prepared from the same as set forth herein may be used to grow or cultivate oysters.

The method of collecting or cultivating oysters grown on the artificial oyster growing structures as set forth herein is not particularly limited, and any process known to one of skill in the art for collecting oysters may be used. For example, the artificial oyster growing structure may be provided in a location where the structure may be seeded with juvenile oysters and the oysters are allowed to grow on and coat the structure over a period of time. In some embodiments, either when the oysters are attached to the structure or as a structure coated with oysters degrades, the shed oysters may be collected for further cultivation using operations that are, for example, either on-bottom, cultivated freely on a natural benthic substrate, or caged, and/or placed in bags, for example, mesh bags, or cages that are placed directly on the bottom or suspended above the bottom to various heights above the bottom on racks and the like, and/or floated above the bottom, for example, at the water's surface. In some other embodiments, the artificial oyster growing structure may be seeded with juvenile oysters in a first location and oysters allowed to grow on the structure, then moved to a second location in which the oysters are cultivated either directly from the structure or as the structure degrades, the shed oysters are collected for further cultivation using operations that are, for example, either on-bottom, cultivated freely on a natural benthic substrate, or caged, and/or placed in bags, for example, mesh bags, or cages that are placed directly on the bottom or suspended above the bottom to various heights above the bottom on racks and the like, and/or floated above the bottom, for example, at the water's surface.

In other embodiments, the shedding process of oysters from the artificial oyster growing structures may comprise twisting and rolling of panel structures comprising the ephemeral substrate material after a period of time following seeding. Although this period of time is not particularly limited, this process may be performed at a point in time of oyster growth/cultivation wherein the oysters are mostly attached to the panel structure and not to each other. This period of time may be 2-12 months or any time in between, for example, about 2, 3, 4, 5, 6, 7, 8, 9, 10, 11, or 12 months after seeding of the artificial oyster growing structure. The shed oysters may be size sorted, for example, using a series of sieves. The mesh size of these sieves may be, for example, 2, 6, 12 and 20 mm, or larger mesh sizes as the age and size of the oysters increases.

The shedding process may remove most, for example, about 70-90%, of the attached oysters. Following oyster shedding, the artificial oyster growing structures may be redeployed for further growing out of oysters remaining attached to the structure's ephemeral material. This process of growing out and cultivating of oysters using the artificial oyster growing structure may be performed more than once, and may be repeated multiple times, for example, two, three, four or more times. The shed oysters collected by the shedding process may be deployed following collection for caged grow out, for example, growing in mesh cages, or for free-on-bottom grow out.

In still other embodiments, the ephemeral substrate material as set forth herein may be used for creating an artificial aquatic bottom overlay. The artificial aquatic bottom overlay or overlayment, and its structure and size, are not particularly limited, and may be composed of sheet, panels and the like prepared from the ephemeral substrate material. Sheets and panels comprising ephemeral substrate material of the invention may be deployed to modify the structure of the aquatic or submerged bottom. For example, the sheets and panels may be deployed as an overlay to prevent the movement of bottom sediments away from a location, to provide an environment that may be conducive to the growth of submerged aquatic vegetation, and/or to prevent the subsidence of bivalve mollusks, for example, oysters, into bottom sediments, such as on a mud flat or mud bed. The aquatic bottom overlay may be used to, for example, produce natural benthic reefs of native oysters.

In still other embodiments, the ephemeral substrate material as set forth herein may be used for creating reef structures, for example, shoreline or near-shore reefs and structures and arrays, that may be used as barriers to shoreline erosion, i.e., for use in controlling shoreline erosion. For example, a reef structure may be used that will infill with estuarine sediments to create an estuarine habitat that can protect adjacent shorelines from erosion.

In still other embodiments, the ephemeral substrate material as set forth herein may be used for creating reef structures that may be used for saltmarsh grass colonization. For example, the estuarine habitat that can protect adjacent shorelines from erosion can become a suitable environment for the growth of saltmarsh grasses.

### Example 1

### Modular Oyster Growing Structures

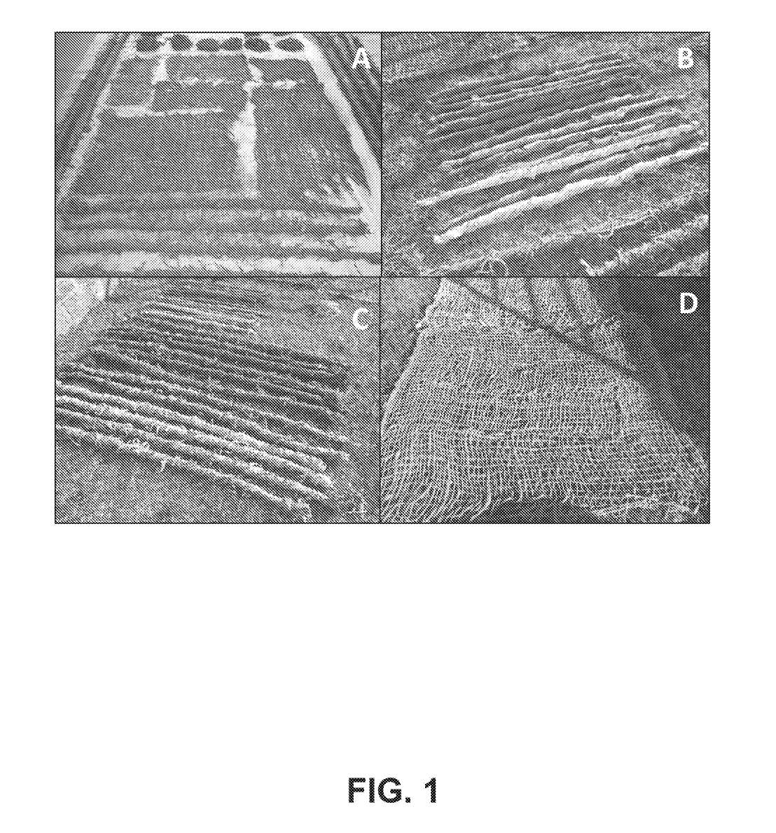

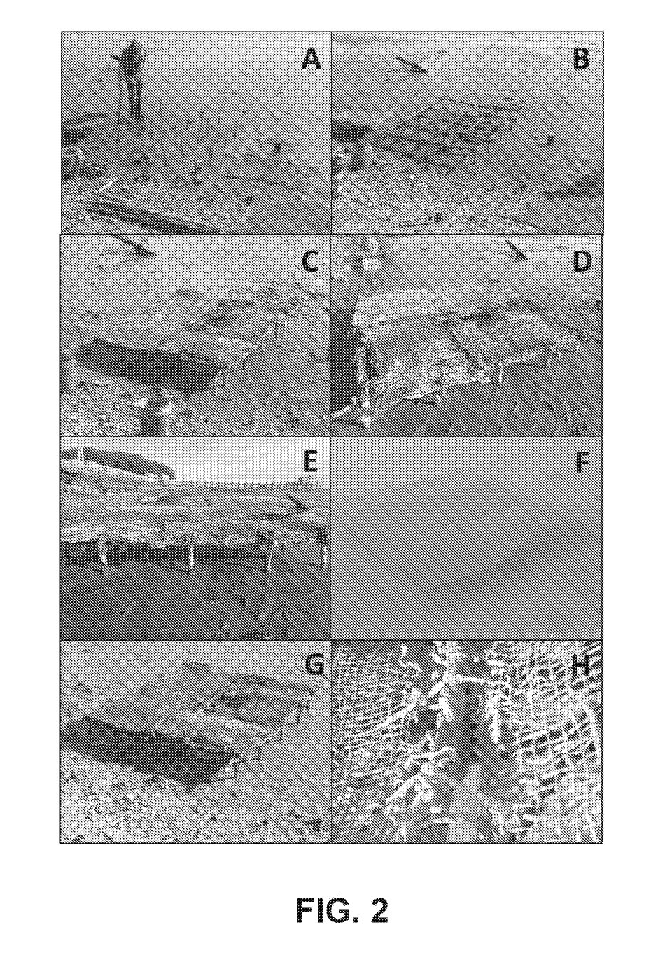

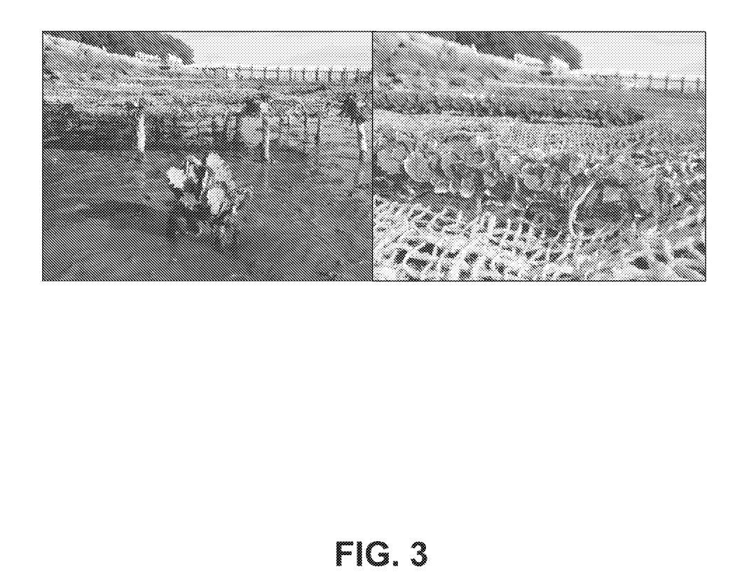

Various embodiments of the ephemeral substrate material prepared as modular oyster growing structure components, rods, rastas, panels and patties, are depicted in FIG. 1, Panel A. Rods and rastas, as depicted in FIG. 1, Panels B and C, may be used in reef framework building. Panels, as depicted in FIG. 1, Panel D have an exceptionally high surface area to volume ratio to maximize oyster density relative to the volume of the artificial oyster growing substrate and a relatively rapid ˜6 month decomposition rate, thereafter shedding single oysters and small oyster clusters that grow a favorable market shape and meat quality. Construction of an artificial oyster growing structure in an intertidal region is depicted in FIG. 2. A newly constructed modular artificial oyster growing structure is depicted in FIG. 3. Depicted in the left panel, the oyster cluster in the foreground growing on protruding steel rebar indicates that the height of the constructed oyster growing structure is within the optimal oyster grow zone for oysters in intertidal environments. Depicted in the right panel is a view of a modular oyster growing structure cross-member showing the exceptionally high oyster densities that can be attained when oyster growing structure components are properly positioned in the intertidal zone. This is a view of the oyster community 6 months after deployment of the cross-member, which has a composition designed to last ˜1.5-2 years (this 6-month old cross-member piece was placed on the newly deployed panel for the visual comparison). The developing oyster community on the framework of the oyster growing structure will more tightly bind its component pieces together, thereby adding resilience to the structure against physical disturbances. The artificial oyster growing structure framework will support multiple deployments of the more ephemeral panels that will be used to grow oysters that may be transferred to other locations. Note too that the empty space between the artificial oyster growing structure platform and the mudflat does not provide a refuge for oyster pests that a reef constructed from a bed of on-the-bottom cultch material, for example oyster shells, does.

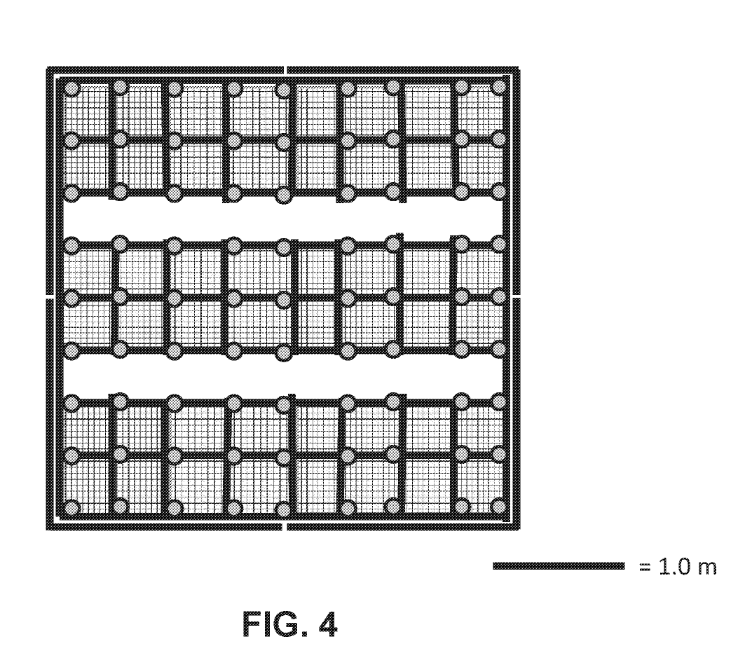

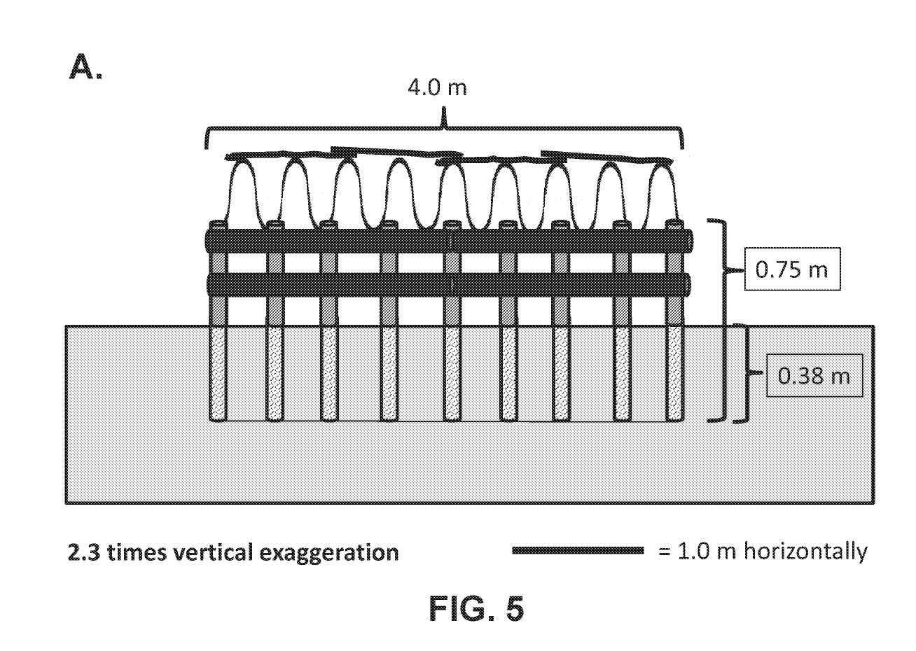

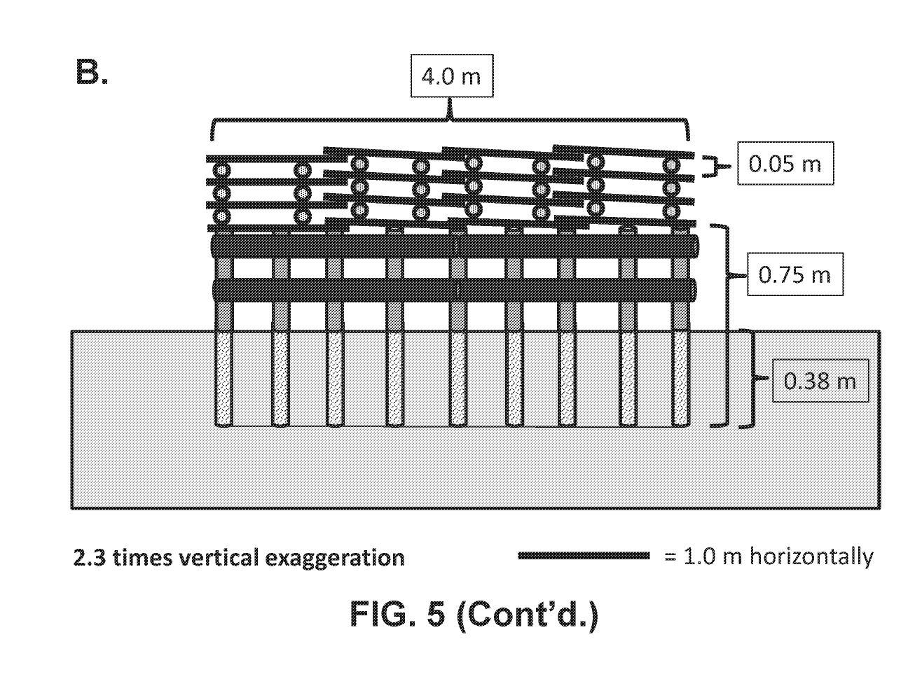

A view from the top of a modular artificial oyster growing structure comprising five structural elements, edge crossbars, interior crossbars, upright rod supports, flat panels and corrugated panels prepared from the ephemeral substrate material is depicted in FIG. 4. An edge view of the modular artificial oyster growing structure is depicted in FIG. 5, Panel A in which upright rod supports are partially buried in the surface on which the artificial oyster growing structure is provided. Corrugated panels are provided on the upright rod supports and crossbars with flat panels on/covering the corrugated panels. FIG. 5, Panel B depicts an edge view of another modular artificial oyster growing structure. Flat panels spaced 5 cm apart by rods or rastas are provided on the upright rod supports and crossbars.

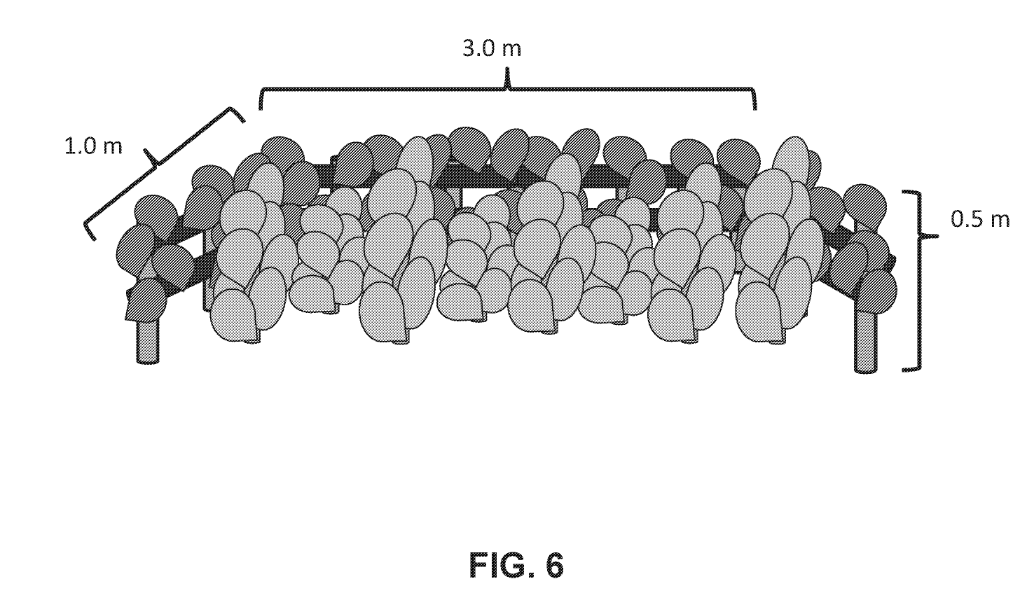

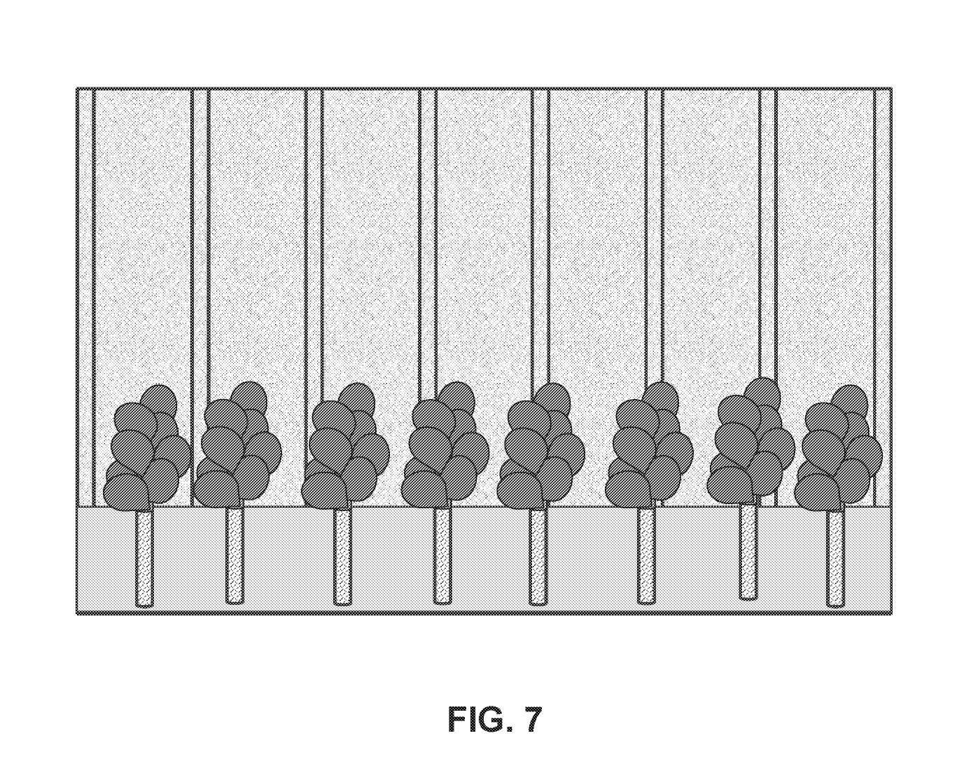

FIG. 6 depicts the transfer of oysters into an estuarine bottom behind a wave/tide shield created from oyster-coated support posts and horizontal connecting rods. FIG. 7 depicts oyster coated posts transferred with attached oysters from a region of high oyster larval settlement after a period of oyster growth and inserted into the sediment at the base of a seawall or bulkhead in an area of low oyster abundance, or at the base of a seawall or bulkhead in an area of high oyster larval abundance but constructed from materials, primarily plastics, that are not conducive to the attachment and growth of juvenile oysters.

### Example 2

### Testing of Substrates and Reef-Building Processes

### Methods

### Project Locations

The UNC-Institute of Marine Sciences (IMS), Morehead City, N.C., was the location for the receipt and storage of materials, the site of substrate manufacturing, processing oyster-coated substrates, and the general base of operation. IMS facilities and infrastructure contributing to the success of this project were (1) the covered loading dock where substrate manufacture occurred, (2) the institute's maintenance shop and its equipment and tools, (3) small boats, (4) areas for substrates storage prior to their deployment to field sites, and (5) importantly, the staff, students and faculty of the institute for their material and labor support for the project. The intertidal region of the IMS shoreline on Bogue Sound was also a location for a portion of the ephemeral substrate deployments and reef building activities.

The main intertidal deployment site for the ephemeral substrates was a 1.29 acre shellfish lease in the lower Newport River estuary in Carteret County, N.C. near the seaport town of Beaufort. The lease was acquired in Juy through the standard shellfish lease acquisition process under the auspices of the North Carolina Division of Marine Fisheries (DMF). The lease site location is on a large intertidal sandbar complex that lies between two major navigation channels of the intra-coastal waterway system. The tide range in this region of the estuary averages ˜1 m, which yields a usable oyster safe zone of ˜0.5 m in the lower half of the tide range. The level of the sand substrate across the lease area was approximately at mean low water level, which is the bottom of the intertidal oyster safe zone.

### Materials

### Fiber Cloths (FCs)

FCs chosen for the ephemeral substrates were jute erosion control cloth (JECC), 5-ounce burlap (5OB) and 7-ounce burlap (7OB). In bulk, JECC comes as highly compressed bolts, 40 inches wide, 225 ft long and ˜10 inches high. This tight packing offers several advantages, although the compression of the fiber bundles presents challenges for infusing the fiber bundles with binders (see later discussion on substrate life-time), which can be overcome through “pre-fluffing” the JECC. One advantage of the compressed, flat bolts is that they can be cut into narrower sections for the production of linear rod-like structural elements. Cutting the compressed JECC bolts was accomplished with a gas-powered, 14-in masonry saw using a composite metal cut blade. Bolts of 5OB and 7OB were 36-in wide, circular and not as compressed as JECC bolts. The 5OB and 7OB bolts were cut into narrower sections for the production of posts, rods and other shapes using a 10-inch metal cut blade on a chop saw.

### Cement Binders

Hydraulic (Portland) cements are relatively modern mineral binders developed in the mid-1800s that harden through the formation of mineral-hydrate complexes that are highly insoluble and structurally interconnected at the molecular level. The addition of rock aggregates and sand to hydraulic cements yields concrete. For the purpose of producing the ephemeral oyster substrates, we used only cements as the binder and hardening agent. The most commonly used Portland cement has a grey color, which is due in part to metal elements, including some heavy metals that in a freely soluble form could be health and environmental hazards. In hardened form, including the small particles produced by the physical degradation of our ephemeral substrates, these metals are not released to the environment. Through a literature search, we learned that the “white” form of Portland cement has lower heavy metal levels than the grey-colored Portland cement. Heavy metals in cements are impurities in main cement ingredients that vary in concentration depending on the source. Thus, it would likely be possible to work with cement manufacturers to produce cements having very low levels of heavy metals.

As an additional means of reducing levels of heavy metals in the substrate binder, we explored the use of hydrated lime (i.e. calcium hydroxide (Ca(OH)₂)), which is a non-hydraulic cement that hardens not through hydration but through the process of carbonation—the absorption of CO₂ to from calcium carbonate. Hydrated lime is a heavy-metal free binder that has been used for millennia in mortar mixes. It is produced though extreme heating of limestone materials to yield calcium oxide (CaO) that when hydrated produces calcium hydroxide. The hardening time for hydrated lime is limited by its absorption of CO₂ and is thus slow, whereas hydraulic cements harden in hours. To overcome the slower hardening time of the hydrated lime, we used mixtures of white Portland cement and hydrated lime to produce a binder with the lowest possible heavy metal concentrations using readily available materials. Mixtures of hydraulic and non-hydraulic cements are “softer” than hydraulic-only cements, yielding an ephemeral substrate equally conducive to oyster larval settlement and juvenile survival but that has the most rapid degradation rates among our different binder formulations. Its relatively rapid degradation offers advantages and opportunities for producing small, single seed oysters, whereas more durable ephemeral substrates offer superior performance for longer-lived reef structures.

### Binder Formulations

For substrates made using standard grey Portland cement and white Portland cement, the dry powdered cements were mixed with an equal weight of water. Once thoroughly mixed using a mixing paddle attached to a hand-held electric drill, the thick liquid mixture was frequently stirred over the subsequent 10-30 minutes. During this preliminary setting period, the liquid mixture thickened to a degree most appropriate for infusing into the fibers of jute/burlap cloths.

To make the binder combining both hydraulic and non-hydraulic cements, we used white Portland as the hydraulic cement. The hydrated lime was purchased as a powder that is typically mixed with water to form “lime putty”. Lime putty will not set when stored such that a layer of water covers the thick putty. For use in mortar mixes, the performance of lime putty as a binder improves the longer it's stored wetted. We typically added 100 pounds of powdered hydrated lime to a plastic 30-gallon trash can and added sufficient water to thoroughly wet the powder and cover the putty with ˜5 cm of water once the putty settled. For our hydraulic/non-hydraulic cement binder, we blended together equal volumes of wetted white Portland (equal weight of water and white Portland cement) and lime putty.

The proportions of substrates made using grey Portland, white Portland and hydrated lime/white Portland were ˜40, 35 and 15%, respectively.

### Substrate Shapes

For this example, we made four different architectural shapes of the substrate. These fell into two basic categories: (1) support/framework and (2) high surface area. The support/framework shapes are linear and cylindrical. These were made by taking long (many meters), narrow (20-40 cm wide) strips of fiber cloth and pulling these through a “dipping tray” filled with wetted binder. As the cloth passed through the tray, we used our hands to physically massage the cloth to work the binder into the fiber bundles. After a prescribed length of the binder-infused cloth was pulled through the tray, it was twisted along its axis and then cut to the desired length. The wetted length of twisted cloth was then placed on a sheet of plastic to cure and harden. Twisting of the binder wetted cloth added additional structural rigidity to the cured product. We used 50B and 70B to make ˜1-m long rods 2-4 cm in diameter with a relatively smooth surface. A major application for the rods was as upright support posts in the construction of oyster reef frameworks. We used JECC in this process to make ˜1.25-m long cylindrical elements 3-5 cm in diameter that we called rastas due to their complex rugose surface that resembles dreadlocks. The rastas were designed to act mainly as cross-members of reef frameworks.

Our high surface area shapes were variations of flat panels made from the 4 ft-wide bolts of JECC. The manufactured panels were layered on reef frameworks to capture large numbers of juvenile oysters on a substrate from which they can be easily dislodged after a period of growth. The fiber bundles of JECC were infused with binder by slowly pulling the cloth from the bolt through a large dipping tray scaled to the width of the JECC. The cloth was massaged and pressed as it was pulled through the tray. The cement-infused JECC exited the tray over an elevated metal edge to squeeze excess binder from the cloth before it was pulled onto a rolling platform on which we placed a 4-m long wood-frame rack covered in plastic. The platform was rolled out from under the dipping tray so that as the cloth was pulled through the tray and over the edge, it can be spread out over the rack laying on the platform. Once cut to tray length, the cloth was pulled tight across its length and width, and the edges of the wetted 4-m long panel were tucked and rolled until they were even with the edge of the rack. This gathering of the cloth exceeding the length and width of the tray perimeter created a hardened, nearly solid edge that gave a workable rigidity to the panels when cut to the standard 1 m×1 m size. The platform and dipping tray were designed so that 10 racks can be laid on the platform without interfering with our ability to roll the platform under the dipping tray. Once we made a set of 4-m long panels, they were re-stacked off the platform and offset side-to-side by ˜¼ of the rack width to help promote air passage between the racks to aid the curing process. Once cured and hardened, the panels were cut into 1-m long sections using a skill saw fitted with a metal cut blade. The newly cured panels were stacked on pallets until being transferred by small boats to the Newport River lease site.

In addition to the framework and high surface area forms of the ephemeral substrate, we made large numbers of a third structural shape called “patties” from scrap fibers and shards of the JECC and wetted cement remaining after a session of panel, rod or rastas making. To manufacture a patty, a large handful of the JECC fibers and shards were dipped into the cement and squeezed and wrung to infuse the fibers with the cement. After thoroughly infusing the fiber mass with cement, excess cement was squeezed from the mass, which was then laid on sheet plastic and molded into a round, somewhat flatten shape with a 3-5 cm diameter hole in the center, much like a doughnut. By using waste JECC and cement to make patties, we virtually eliminated manufacturing waste and created what is likely to become an especially valuable oyster-capturing/growing structure.

TABLE 1
Number of each substrate shape made.

| | Panels | Posts/Rods (total | Rastas (total | |
|---|---|---|---|---|
| | (1-m²) | length-m) | length-m) | Patties |
| Number Made | 396 | 1567 | 1108 | 271 |

### Substrate Deployments to the Newport River Shellfish Lease

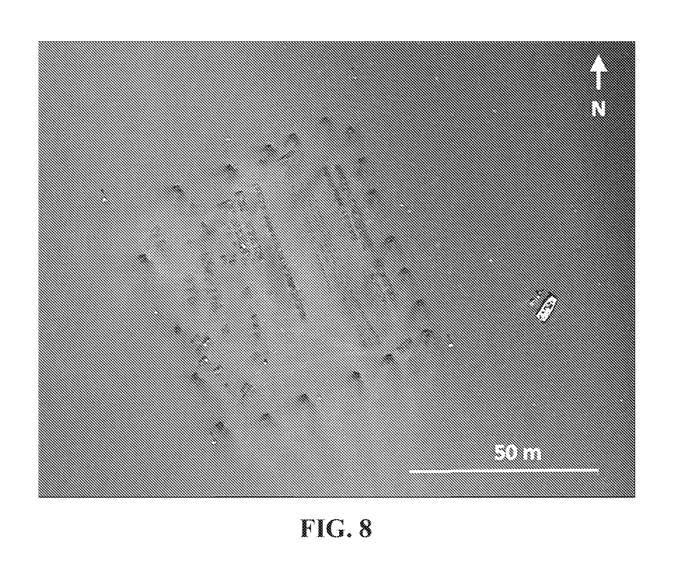

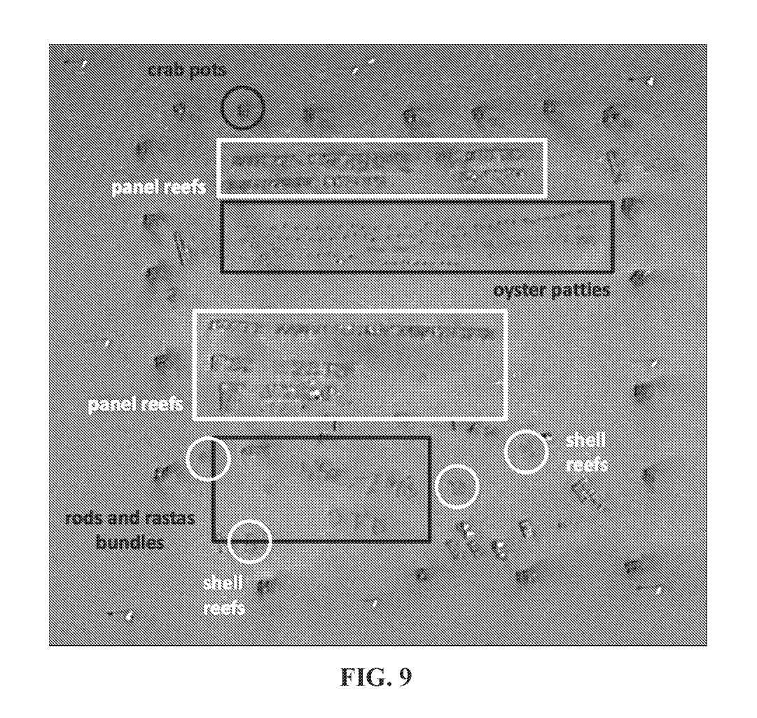

Substrate deployment on the Newport River shellfish lease started in July. The major period of substrate deployment occurred through the middle of August. Because substrate deployment needed to occur on low tides, substrate deployment was an “on-again, off-again” endeavor, as the timing of the work was controlled by tide cycles and regional weather. For example, strong N/NE/E winds drive water levels in the Newport River well above predicted values over entire tidal cycles. FIG. 8 shows a Google Earth view of the lease as it was on October 23rd, and FIG. 9 provides a legend for locations of deployed substrates on the lease.

To build reef frameworks, the 1-m long rods were halved, and half rods were inserted vertically into the sediment, burying approximately one third of the each rod. We made holes for the rods in the sandy sediment by wiggling into the sediment to a pre-determined depth a weighted 1.25 inch PVC post (˜1.5 m long) fitted with a pointed tip. Once the digging post was at the desired depth, it was pulled from the hole and the rod immediately inserted. Using this method, we were able to insert a rod into the sandy sediment in ˜30 seconds. Rods were placed at pre-determined positions on the bar such that their spacing was appropriate for attaching 1.2 m rastas, with upright rods positioned at the ends and middle of each rastas. Rastas were tied to the upright rods using aluminum or galvanized steel wire. Rastas were wired to the rods so that they were ˜10 cm above the sediment surface.

On top of the reef framework, we attached panels, tied end-to-end, across the length of three linear reefs, each between 38 and 40 m long. On each of these three reef rows, we added a second layer of panels. Before adding the second panel layer, two rastas were wired to the top of the bottom panel in a centered “X” pattern to create space between the bottom and top panels. A third layer of panels was added to approximately half of these rows. In addition to these reefs made entirely of the ephemeral substrate, we also laid panels on rebar racks. Panels on the rebar racks were attached in two-panel wide, slightly overlapping layers. Approximately half of the lengths of the rebar racks were covered with a second panel layer.

Rods and rastas not used in used in reef building were placed on the lease in bundles of 10 rods or rastas. Bundles were deployed elevated on rebar racks or placed directly on the sand.

Oyster patties were deployed as stack of 3-5 patties on top of two bricks, one on top of the other, laid on the sand surface. A 1-m length of ¼ inch rebar was run through each patty stack and the bricks and into the sand to hold the stack together and in place. The bricks were used to elevate the stacks because scouring by strong currents around them caused the lower elements (i.e. the bricks) to sink into the sand, while the bottom of the patty stack remained at or above the sediment surface. The patty stacks were deployed in rows within one area of the lease (FIG. 9).

In prior oyster research projects, crab pots have been used as an oyster reef substrate. Pots for these experiments were modified so as not to trap crabs or fishes and were coated with a layer of grey Portland cement. In the previous experiments, oyster larvae settled in great numbers and grew quickly on crab pots treated in this manner. We deployed 80 similarly treated crab pots as a control for oyster larval settlement and growth versus the new ephemeral substrates. The crab pots were arranged in groups of 4 in a square pattern and set around the perimeter of the lease (FIG. 9) as a deterrent to boats venturing inside the lease boundaries and inadvertently damaging our substrates.

The final substrate type deployed on the lease was the traditional bed of oyster shells, which has been assumed by many to be the superior substrate for oyster settlement and growth. We created four 2 m×2 m×0.1 m (l-w-h) reefs, each containing 10 bushels of oyster shell spread evenly across the reef foot print. These reefs were similar to ones we successfully created on another sandflat near Beaufort in 2011 (Fodrie et al. 2014, Rodriquez et al. 2014, Ridge et al. 2015).

### Results and Discussion

### Oyster Larval Settlement Periods

Many local estuarine ecologists posit that the major period of oyster recruitment in North Carolina occurs in the early summer months. Based on a lack of oyster settlement by late July on oyster shells deployed around the Newport River lease site two months prior, there were some concerns that the current year be a poor recruitment year for oysters in the Newport River. However, we observed newly settled oysters on the substrates by the middle of August. This initial wave of recruitment was followed by multiple additional pulses of oyster larval settlement into December. Thus, by the end of the year, we had multiple cohorts of different ages and sizes of oysters on the substrates. A low level of oyster larval settlement was also observed in the following January.

### Estimates of Seed Oyster Yields on Deployed Substrates

This section of the report provides pictures of each substrate type before and after oyster recruitment and estimates of seed oyster yields on each substrate type. The yield numbers are based on quantification of sub-samples of the different substrate types that represented high levels of oyster recruitment and growth, which were typical across all of the substrate materials places on the lease site. However, for the seed oyster yield calculations, we used oyster density numbers that were approximately half that of the higher, but commonly measured density numbers. Thus, our estimate of total seed oyster production for this 1.3 acre lease is in all likelihood a conservative number. This conservative number is what we proposed the North Carolina Division of Marine Fisheries use to establish lease production levels. The combined yields of seed oysters on all substrates were then used to calculate the percent of the 5-year quota required for the 1.3 acre lease.

### Rods and Rastas

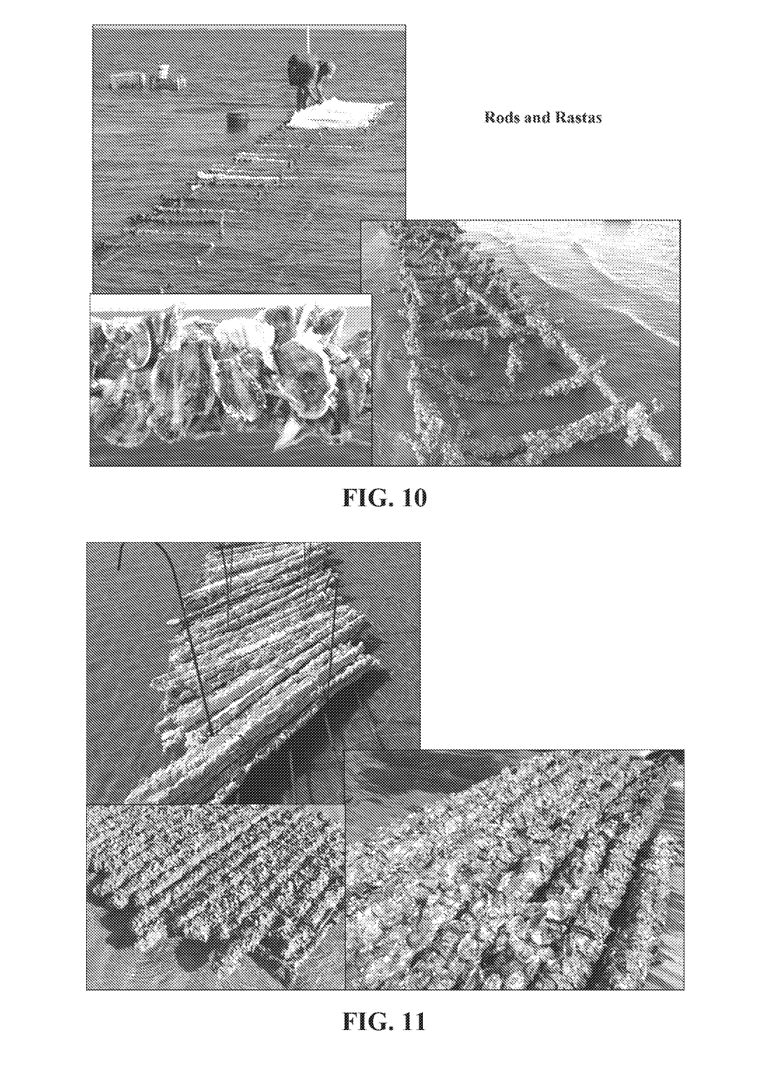

Rods (smooth surface) and rastas (rough surface), as shown in FIGS. 10 and 11, whole and in parts, created a reef framework on which overlaying panels, as shown in FIG. 12, were attached. After removing oyster-coated panels, the remaining framework was also densely coated with oysters (FIG. 10, lower right). In total, ˜1500 and ˜1100 rods and rastas, respectively, were deployed on the lease.

Rods and rastas were moved to the lease in bundles of 10. Rods and rastas not used in reef construction were eventually opened and the rods/rastas laid out on racks. Settled oysters grew densely on these non-reef rods/rastas. Oysters were also shed from a portion of these non-reef rods and rastas.

TABLE 2
Estimates of seed oyster yields on rods and rastas.
RODS

| | Total Length | | |
|---|---|---|---|
| Number of | of Rods | Oyster Density | Total Seed |
| 1-m Long | Deployed | per m Length | Oyster Yield |
| Rods Deployed | (1 m per rod) | of Rod | on Rods |
| 1567 | 1567 | 500 | 783500 |

RASTAS

| Number of | Total Length | Oyster Density | Total Seed |
|---|---|---|---|
| 1.25 m-Long | of 1.25 m- | per m Length | Oyster Yield |
| Rastas Deployed | Long Rastas | of Rasta | on Rastas |
| 1108 | 1385 | 1000 | 1385000 |

380 m² of panel was deployed in raised rows with 2-3 panels layered on the reefs. Rastas were used to create space between the layers. Oyster densities were typically ˜5000 per m² of panel.

TABLE 3
Estimate of seed oyster yield on 1-m² panels.

| Total Number | Average Oyster | Total Seed |
|---|---|---|
| of 1-m² Panels | Density per | Oyster Yield |
| Deployed | Panel | on Panels |
| 380 | 2500 | 950000 |

### Oyster Patties

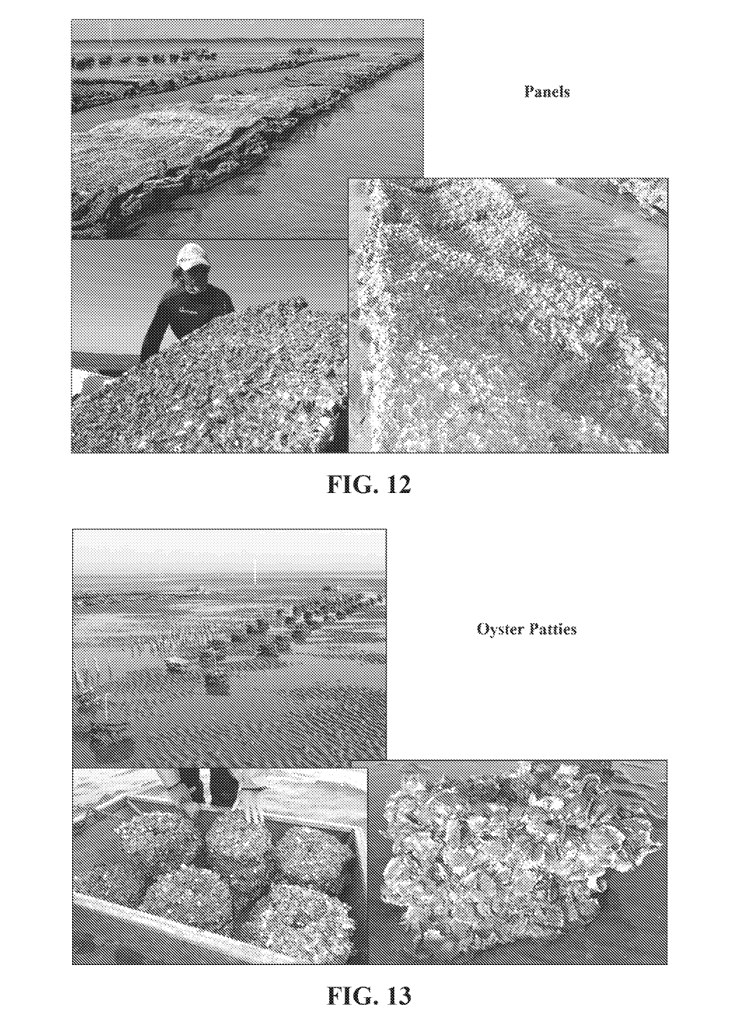

Patties were deployed in stacks of 4-5, as shown in FIG. 13. All surfaces of the patties were colonized by oysters to an average density of ˜1000 oysters per patty. 271 patties were deployed on the lease. 50 oyster-coated patties were donated to the North Carolina Division of Marine Fisheries for transfer to an artificial reef in the low salinity region of the New River near Jacksonville, N.C. We also transferred oyster-coated patties to lower salinity areas of the Newport River estuary and to the North River estuary. Surveys of these patties 3-4 months after their transfers, found virtually no mortality of the oysters and substantial increases in the size of the oysters.

TABLE 4
Estimate of seed oyster yield on oyster patties.

| Total Number | Average Oyster | Total Patty |
|---|---|---|
| of Patties | Density per | Seed Oyster |
| Deployed | Patty | Yield |
| 271 | 1000 | 271000 |

### Oyster Shell Reefs

Four 2 m×2 m×0.1 m oyster shell reefs were constructed on the lease. Each was made from 10 bushels of oyster shell scattered evenly across the reef footprint. Oyster settlement rates were high but oysters can only colonize the exposed surface of the reefs and many shells were buried by shifting sands.

TABLE 5
Estimate of seed oyster yield on the oyster shell reefs.

| | | | Total Seed |
|---|---|---|---|
| Number of | Total Surface | Estimated | Oyster |
| 2 m × 2 m × 0.1 m | Area (m²) | Oyster | Production |
| Oyster Shell Reefs | for Oyster | Density | on Shell |
| Constructed | Settlement | per m² | Reefs |
| 4 | 16 | 100 | 1600 |

### Crab Pots

80 cement-coat, non-trapping crab pots were deployed around the lease as 4-pot sets. Oysters colonized all exposed surfaces of the pots. Small pieces of stray substrate were collected and placed inside and between some crab pots. These materials also became densely coated with oysters.

TABLE 6
Estimate of seed oyster yield on crab pots.

| | Total Exterior | Total Crab | | |
|---|---|---|---|---|
| | and Interior | Pot Surface | Estimated | Total Crab |
| Number of | Panel Area for | Area for | Oyster | Pot Seed |
| Crab Pots | Oyster Settlement | Oyster Settlement | Density | Oyster |
| Deployed | (m²)¹ | (m²) | per m² | Yield |
| 80 | 1.5 | 120 | 2500 | 300000 |

¹Crab pot dimensions: 0.61 m × 0.61 m top and 4 × 0.61 m × 0.43m sides. Internally there are two 0.61 m × 0.30 m panels between upper and lower chambers. We assume only 0.30 m in the vertical dimension along the side is available for oyster settlement and growth. Crab pot dimensions for oyster production calculation: top (0.61 m × 0.61 m) + sides (0.61 m × 0.30 m × 4) + internal panels (0.61 m × 0.30 m × 2) = 1.5 m².

TABLE 7
Total seed oyster yield across all substrate
types deployed on the shellfish lease.

| | | | | | | Total Seed |
|---|---|---|---|---|---|---|
| | | | | | Shell | Oyster |
| Crab Pots | Panels | Patties | Rods | Rastas | Reefs | Production |
| 300000 | 950000 | 271000 | 783500 | 1385000 | 1600 | 3691100 |

### Calculation of Percent of 5-Year Seed Oyster Planting Quota Met on the Newport River Shellfish Lease in Year One (BL1800852/WC1800861).

North Carolina Division of Marine Fisheries Conversion Factor: 300 seed oysters=1 bushel North Carolina State Law: a water column lease must produce and market 10 bushels per acre per year OR plant 100 bushels of cultch or seed oyster equivalents (=30,000 seed oyster).

Thus, the 5-year quota per acre is 150,000 seed oysters.
Lease Acreage=1.3 acres
1-yr seed oyster quota=39,000; 5-yr quota=195,000

### Seed Oyster Yield in Year One=3,691,100

Percent of 5-yr quota made=(3,691,100/195,000)*100=1893%

Shedding Oysters from Panels for Managed Aquaculture

Producing oysters with an enhanced market value is achieved by growing oysters as “singles” and in environments, natural or managed, that promote the development of a rounded, deep-cupped shell shape. Typically, these shell attributes are generated by growing groups of single oysters confined in cages at appropriate densities and having sufficient physical agitation of the caged oysters to “chip” away sharp growing edges of the shell. The physical agitation of oysters can be achieved through wave/tide-driven movement of the cages or by periodically removing oysters from the cages and tumbling them. Our growing system initially results in juvenile oysters growing densely aggregated (FIGS. 10-13), which, if left to continue growing in this situation, would result in the oysters developing long, skinny shells in an effort to rise above and out-compete neighboring oysters for access to overlying waters. This long, skinny shell shape has a substantially lower market value.

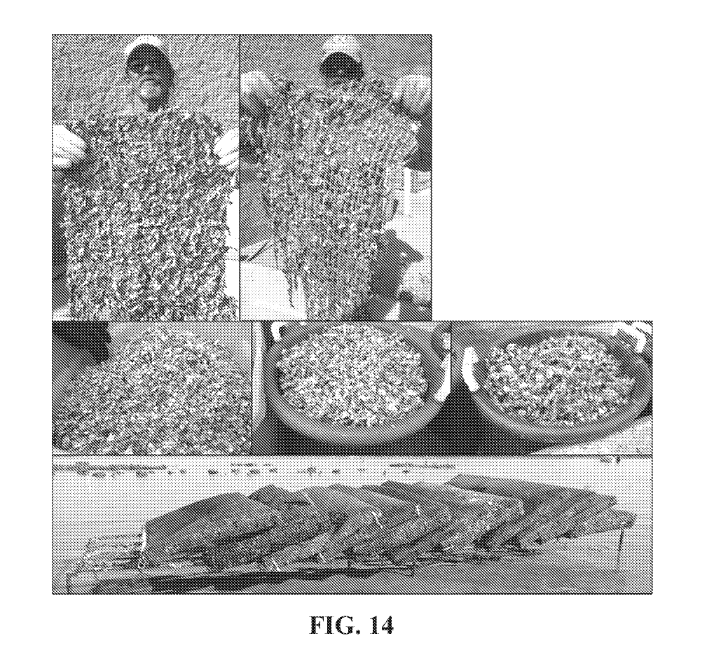

By late September, the density of juvenile oysters on all substrate types increased dramatically, as had the sizes of the oysters, with some oysters reaching more than 30-40 mm in shell length. On October 9th, oyster densities and sizes reached a level that lead us to initiate oyster shedding to obtain single oysters and small clusters that will be used as seed oysters for managed aquaculture operations. For the shedding process, oyster-coated panels were collected from the Newport River lease and returned to IMS, where we had seawater facilities to house the collected panels and the shed oysters. Prior to beginning the shedding process (FIG. 14), pictures were taken of both sides of some panels with a ruler laid over the panel for scale. For these panels, pictures were also taken after shedding oysters to determine the number of oysters remaining on the panel material. The shedding of oysters from panels was done by twisting and rolling the cloth. Doing this caused large numbers of oyster to detach from the panel. Importantly, oysters at this point in time were mostly attached to the panel and not to each other. Thus, the vast majority of oysters being shed, now ˜2 months after we observed the first cohort of recruits on the substrates, were obtained as mostly small single oysters and shed from the panels with little mortality. The shed oysters were then size-sorted by passing them through a series of sieves with progressively smaller mesh size. The series of sieves created for the sorting had the following mesh-hole widths from the largest to smallest mesh sizes: 20, 12, 6 and 2 mm. For each size fraction, a total wet weight (damp but not dripping wet) was obtained, from which subsamples were removed, weighed and live oysters counted. From these counts, we determined that densely coated panels had 5000 live oysters each. While some panels did not catch as well and some caught more, this average is an impressive number, particularly given the very low numbers of boxes (dead oysters with both valves of the shell attached to each other) and empty left valves (the bottom valve, commonly called the left valve, is the one that attaches to a substrate) observed on the panels. The sorted oysters were placed in mesh cages of an appropriate mesh dimension to contain the oysters. These caged oysters were then deployed on elevated racks either behind IMS in Bogue Sound or on the shellfish lease in the Newport River. The shedding process removes ˜70-90% of the attached oysters (FIG. 14). The worked cloth with remaining attached oysters was redeployed either in cages or free-on-bottom for continued grow-out.

The shedding of oysters from panels and caged panel materials occurred at multiple times since we initiated shedding. At the last round of oyster shedding, oyster sizes had increased while the density appeared to decreased slightly, likely due to increased crowding of the growing oysters causing a low level of on-going mortality. Importantly, the oysters were still easily dislodged from the panels, but with more clusters coming off the substrate than in earlier shedding sessions. The last shedding still yielded large numbers of smaller oysters that likely settled onto the panels in the month or two prior to collecting the substrate from the lease for shedding oysters. However, we found very few oysters of the smallest size class that were plentiful when we first started shedding oysters.

Post-shedding, oysters were held in mesh cages either in Bogue Sound behind IMS or on the Newport River lease. At the time of the last shedding, we estimated that we had in hand ˜400,000 shed oyster among three different class sizes. We deployed a portion of these shed oysters free-on-bottom on a shellfish lease in a low salinity area further up the Newport River. Aliquots of the shed oysters were also distributed to other shellfish growers in the Newport River estuary, in Jarrett Bay along the western shore of Core Sound and in the southern region of the North Carolina coast near Hampstead. Free-on-bottom and caged grow outs were set up on these leases to compare their efficacy. This distribution of oysters will provide valuable information on survival and growth rates of oysters originating from a high salinity, intertidal environment transferred to multiple different salinity regimes and the relative yields of market-quality oysters using two different grow out methods.

### Deterring Theft of Oysters

Concurrent with the rise in caged-based aquaculture of oysters has been a rise in the theft of product. Caged oysters, particularly those in floating cages, are a package that can be quickly cut from their mooring system and carried away. Theft typically occurs at night, and remote leases are most often targeted. Theft can be difficult to prevent, and when caught and convicted, civil and criminal penalties imposed by judges have historically been too lenient to be an effective deterrent. While stiffer penalties may deter some theft, without a means to positively identify ones oysters, once the theft of oysters has occurred, it's unlikely the perpetrators would be caught.

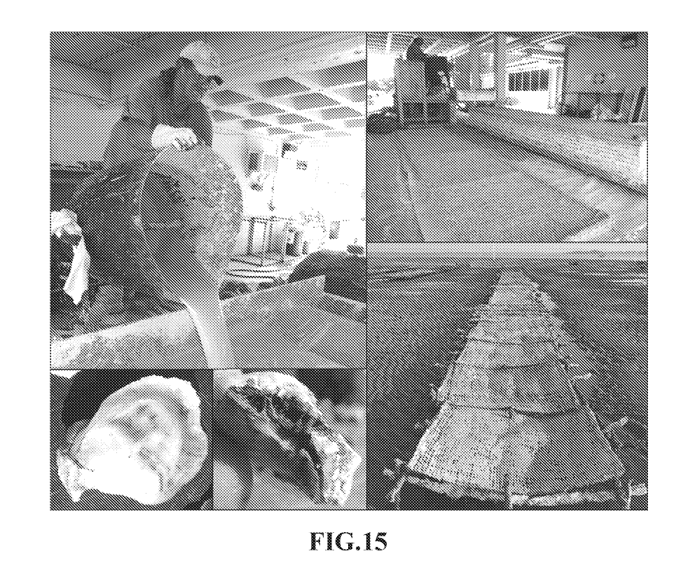

The composition of the new ephemeral substrate provides a unique means for identifying oysters grown with this system and thus deterring theft. For oysters shed from panels, their bottom valve may carry with it two possible identifying features: (1) an embedded chip of the cement-based binder and/or (2) an indentation of a fiber-bundle (FIG. 15). While not all oysters shed from ephemeral substrates will have these unique identifying features, a substantial portion of them will. Furthermore, during substrate manufacturing, we add a variety of potential markers to the wetted binder, including dyes, colored particles or other materials visible to the eye or not, before it is infused into the fiber bundles of the cloths. Cement dyes and other dying agents are used to color panels, for example, pink, red and blue. Among the oysters shed from these colored panels, were oysters with embedded chips of the colored binders (FIG. 15). Even without coloring, just the presence of binder embedded in the shell points to the origin of the oyster. With or without coloring the binder, a substantial number of oysters shed from the substrates possess a tubular indentation in their left valve as it grew around a hardened fiber bundle. Once dislodged from the substrate, shell trenching remains as oysters do not add new shell material to the former substrate attachment point as they grow. This anti-theft feature is unique to the novel ephemeral substrate system. Once these features of oysters produced from the ephemeral substrate become known among wild harvesters, growers, seafood dealers and distributors, the rate of theft from growers using the novel ephemeral substrate system should be low.

### Mapvertising

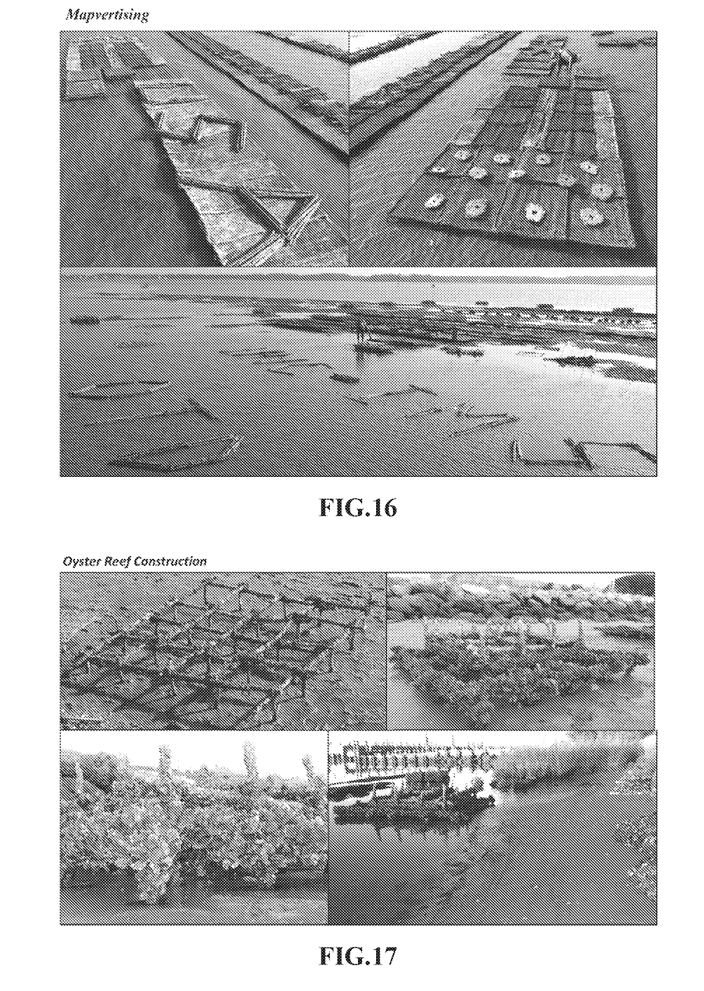

“Mapvertising” is the concept and act of advertising on, or in direct relation to maps; generally referring to online maps, but also including rooftops and other large, physical structures positioned for overhead viewing opportunities. Because intertidal sandflats constitute a large, natural “canvas”, and the shellfish lease in the Newport River lies under an approach path to the Beaufort airport, we arranged some of the oyster substrates to form entity identifying logos and lettering (FIG. 16). Importantly, FIGS. 8 and 9 demonstrate that Google Earth can be a premier mapvertising viewing platform capable of reaching extremely large audiences. As our inaugural mapvertising exercise, bundles of rods were arranged on the sand and on top of panels and deployed colored panels in ways to express our great appreciation for living in the United States of America and giving credit to the UNC Institute of Marine Sciences and the UNC Office of Technology Development for their support (FIG. 16). The acronyms were somewhat scattered by a large storm; however, “OTD” is clearly visible in the Google Earth image of this area (FIGS. 8 and 9). Larger, more robust structures created from our substrates securely anchored in the sediment would be visible from much higher viewing altitudes and last for many months and even years.

### Oyster Reef Construction

FIG. 17 shows an emergent intertidal oyster reef created along the shore of the IMS campus on Bogue Sound. We constructed the lower layer of the reef using bare rods and rastas to create the framework and to anchor the structure to the bottom in January. Oyster recruitment to the framework began in July. Three months later, the reef framework was expanded upward to the maximum extent of intertidal oyster growth using rods and rastas retrieved from the Newport River lease that were densely coated with oysters. Since its construction, the reef has not moved and is becoming increasingly resilient to physical disturbances as the oyster community on the structure matures. Over time, the open space within the 3-dimensional structure of the reef will fill in with living oysters. As these oysters grow and new oysters recruit to the reef during subsequent years' reproductive seasons, this reef should become an oyster shell/living oyster platform that will rapidly infill with estuarine sediments. At this point, it will become a suitable environment for the growth of saltmarsh grasses. The transition from intertidal oyster reef to saltmarsh habitat occurs naturally under some circumstances, but this evolution typically occurs over decades. When the lower reef framework was constructed, the elevation of the sediment under the lower horizontal frame was ˜10 cm from front-to-rear (FIG. 17, top left). Six months after oysters started recruiting to the reef framework, the sediment surface front-to-rear was sloping upward by ˜10 cm and a sand spit formed behind the reef (FIG. 17, lower right). The managed evolution from sandflat to oyster reef to oyster/saltmarsh habitat can become an important tool for creating new estuarine habitat and land to protect adjacent shorelines from erosion and wave energy.

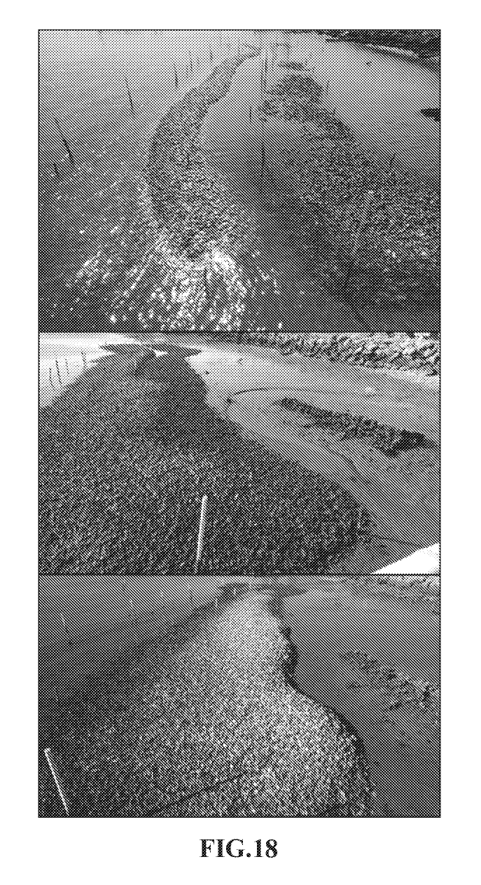

In contrast to the stability of the reef structure created along the IMS shoreline from the ephemeral substrate (FIG. 17), a research project placed two parallel rows of oyster shell reefs along the IMS shoreline. Although these reefs were densely colonized by oysters soon after their construction, the depth of the outer edge of the offshore reef exposed settled oysters to high levels of predation and competition that soon killed off the oysters on the deep, outer edge of the reef. At this point, waves and currents, and in particular boat wakes, began washing the unconsolidated shell bed back toward the shoreline and over the living portions of these reefs. FIG. 18 shows the progression of this destruction over time. While the physical destruction of these reefs was occurring, the nearby reef constructed from the ephemeral substrate suffered no damage from waves, currents and boat wakes.

Given our success with de novo creation of oyster reefs in high energy environments like those of our Newport River lease and along the IMS shoreline, it is reasonable to expect that our reef building methods with the novel ephemeral substrate will be highly successful in lower energy areas as well. In low wave energy environments, shoreline erosion occurs mostly due to increasing sea level and increasing tide ranges inundating and weakening terrestrial soils. Eroding portions of the Carrot Island shoreline in the Rachel Carson National Estuarine Research Reserve (RCNERR) that lie across Taylors Creek from Beaufort are an example of this type of erosion problem. Shoreline erosion driven by high water levels is a widespread and increasingly severe problem (e.g. NOAA Technical Report 2014).

Our oyster reef building system is likely applicable in environments sure to test reef resilience. An example of such a location in dire need of attention and possibly amenable to remediation by our oyster reef/saltmarsh creation system is also in the RCNERR. At the western end the RCNERR is Bird Island, which forms a barrier between the Atlantic Ocean and Beaufort's waterfront and Pivers Island, the latter being home to the Duke University Marine Lab and NOAA's Southeast Fisheries Center. Over the past two decades, the region of Bird Island across from Pivers Island and the downtown portion of the Beaufort waterfront has narrowed by ˜25%. Meanwhile, over the past 4 years, severe erosion of the western end of Shackelford Banks has doubled the width of Beaufort Inlet. The increased width of the inlet now allows more ocean wave energy to reach Bird Island. Only a slim sandy dune line now separate the more energetic waters fronting Bird Island from its shallow lagoon, which opens on the other side of the island in front of Pivers Island. Beaufort's waterfront, Pivers Island and surrounding areas are highly populated and exceptionally valuable lands that include many residences, historical properties, a lucrative business hub, high occupancy dockage, and academic and federal research campuses. Our materials and methods can establish oyster reefs that trap sediment and foster the colonization of salt marsh grasses, thereby stabilizing Bird Island's shoreline by employing the power of one of nature's greatest foundation building species in shoreline erosion control.

### Oyster Habitat Restoration

The North Carolina legislature has directed the North Carolina Division of Marine Fisheries to prepare multiple reports related to issues of oysters in North Carolina, which were to include means of promoting oyster aquaculture and restoring wild oyster populations, both in no-take sanctuaries and harvest-open areas. Draft recommendations on the rehabilitation of wild oyster stocks and on promoting oyster aquaculture call for substantial increases in funding for oyster-related projects and inclusion, where appropriate, of private businesses to help accomplish the mission.

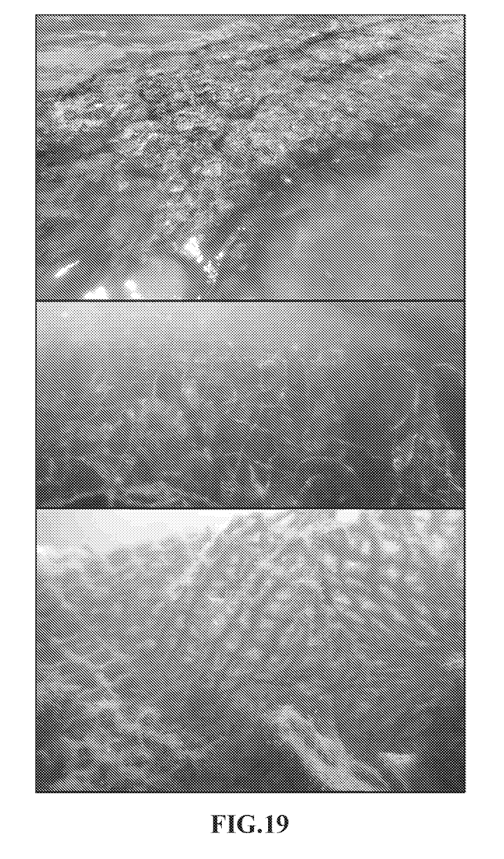

With our donation of 50 oyster-coated patties to the North Carolina Division of Marine Fisheries for testing the survival and growth of oysters transferred from high salinity, intertidal seed areas to lower salinity environments, and through their production reporting system for shellfish leases, Division of Marine Fisheries staff involved in oyster restoration and aquaculture are learning about our oyster growing success and restoration applications of our different products. Through continued interactions with Division staff, we anticipate that their increasing awareness and knowledge of our oyster growing accomplishments will lead them to view our materials and methods as far superior to many presently used restoration techniques, some of which are increasingly coming under fire for being largely ineffective and in fact polluting. For example, the North Carolina Coastal Federation and The Nature Conservancy have long used oyster shells encased in plastic mesh bags to construct foundations for oyster reefs in shallow subtidal and intertidal habitats. However, many of their projects have placed shell bags outside of oyster safe zones, and the vast majority of the bags used in a project are buried under other bags simply to build vertical relief. These mounds of bagged oyster shell often fail to develop long-lived oyster communities, and instead become infested with oyster pests. Further, without a protective layer of live oysters, many mesh bags tear apart, which compromises the integrity of the mounds and sheds plastic into surrounding habitats (FIG. 19). This and other poor restoration practices have been allowed to occur because (1) there are often no requirements for post-construction monitoring of oyster density and condition on these structures and (2) there is widespread belief among oyster restoration practitioners that oyster shell is the superior oyster substrate in all estuarine environments. Once in place, mounds of bagged oyster shells, loose oyster shell, rock and other highly robust materials become long-lived features in the estuaries. This work has amply demonstrated that our ephemeral oyster substrate offers a highly effective means of rapidly creating oyster-dense habitats and structures without the sizeable risks associated with the use of long-lived or permanent fill materials to create reef foundations.

### CONCLUSIONS

The results of our oyster growing efforts using the novel ephemeral substrate have yielded great success in rapidly establishing immense oyster populations by deploying our novel ephemeral substrate in nature's greatest oyster hatchery and nursery—intertidal zones in high salinity environments. The high annual availability of oyster larvae in coastal waters and expansive growing areas offered by intertidal flats allow seed oyster production using our new system to far exceed that of land-based hatcheries. By settling and growing oysters on different dimensional elements of our novel substrate and varying its durability, we have the versatility to direct settled oysters into multiple product lines appropriate for entry into established aquaculture markets and developing markets in oyster habitat restoration and shoreline stabilization. Advantages of our ephemeral oyster substrate materials and estuarine habitat creation methods include having an environmentally benign substrate and the ability to create structures with an open 3-dimensional space that fills with growing oysters rather than being a solid voluminous structure that only grows oysters on its exposed surfaces and do not create an environment conducive to a transition to saltmarsh habitat as the substrate elevation in and around the oyster reef rises to an level optimal for saltmarsh grasses. Given the structural diversity and dimensional shaping possible with our unique substrate, we can customize reef building applications to fit individual situations and requirements, including in addition to de novo reef creation, modifications to existing structures, for example bulkheads, groins and docks, in ways not possible with other substrates. Similarly, our substrate can be readily incorporated into existing living shoreline projects to enhance sedimentation rates and stabilize sediments for the promotion of marsh grasses while literally putting oyster life in the living shoreline—a critical triad for the support of multiple aquatic species that foster a healthy environment. Importantly, should a restoration site prove to be inappropriate for the long-term persistence of oysters, our substrates fade away. In stark contrast, inappropriately sited reefs using long-lived foundation materials, like the commonly used oyster shells and marl rock, leave behind an enduring fill that can facilitate populations of oyster pests to the detriment of viable oyster populations in surrounding waters.

Through our work on multiple successful oyster restoration projects and with the development of the novel ephemeral substrate, we have the knowledge base and materials to make substantial advances helping restore oyster populations in, for example North Carolina, as well as in other regions and with multiple oyster species. In addition to the environmental benefits of boosting oyster numbers in our estuarine waters and along our shorelines, there are the immense economic benefits of creating jobs and business opportunities in support of commercial fishing communities and waning working waterfronts. Not to be overlooked too are the contributions this substrate and our methods make toward innovation and problem solving for the improvement of oyster aquaculture and estuarine habitat restoration.

The ephemeral oyster substrate and methods for its use create a solid foundation to meet societal needs for sustainably produced foods (especially proteins), a clean, healthy environment and safer coastal living. In addition to growing oysters for food, further uses of the ephemeral oyster substrate may be directed toward oyster habitat creation for the enhancement of oyster resources for commercial and recreational harvest, the development of oyster sanctuaries, and the strategic de novo creation of emergent intertidal oyster reefs and saltmarsh to mitigate increasing risks to coastal communities associated with rising water levels and shoreline erosion.

### REFERENCES

Beck, M. W., Brumbaugh, R. D., Airoldi, L., Carranza, A., Coen, L. D., Crawford, C. et al. 2011. Oyster reefs at risk and recommendations for conservation, restoration, and management. BioScience, 61, 107-116
Bishop, M. J. & Peterson, C. H. 2006. Direct effects of physical stress can be counteracted by indirect benefits: oyster growth on a tidal elevation gradient. Oecologia, 147, 426-433.
Chestnut, A. F. & Fahy, W. E. 1953. Studies on the vertical distribution of setting of oysters in North Carolina. Proceedings of the Gulf and Caribbean Fisheries Institute, 5, 106-112.
Coker, R. E. 1905. Oyster culture in North Carolina. The North Carolina Geological Survey, Economic Paper No. 10.
Coker, R. E. 1907. Experiments in oyster culture in Pamlico Sound N.C. North Carolina Geological and Economic Survey Bulletin No. 15.
Coker, R. E. 1930. Future of the oyster in North Carolina. J. Elisha Mitchell Society, 45:338-349.
Dean, B. 1892. Report on the present methods of oyster-culture in France. Bulletin of the U.S. Fish Commission for 1890, pp. 363-388.
Fodrie, F J, A B Rodriguez, C J Baillie, M C Brodeur, S E Coleman, R K Gittman, D A Keller, M D Kenworthy, A K Poray, J T Ridge, E J Theuerkauf and N L Lindquist. 2014. Classic paradigms in a novel environment: inserting food web and productivity lessons from rocky shores and saltmarshes into biogenic reef restoration. Journal of Applied Ecology 51:1314-1325.
Grabowski, J. H. & Peterson, C. H. 2007. Restoring oyster reefs to recover ecosystem services. Theoretical Ecology Series, 4, 281-298.
Graves, C. 1904. Investigations for the promotion of the oyster industry in North Carolina. Pages 247-341 in the U.S. Fish Commission Report for 1903. Government Printing Office, Washington, D.C.
Lenihan, H. S. & Peterson, C. H. 1998. How habitat degradation through fishery disturbance enhances impacts of hypoxia on oyster reefs. Ecological Applications, 8, 128-140.
NOAA Technical Report NOS CO-OPS 073. 2014. Sea Level Rise and Nuisance Flood Frequency Changes around the United States
Powers, S. P., Peterson, C. H., Grabowski, J. H. & Lenihan, H. S. 2009. Success of constructed oyster reefs in no-harvest sanctuaries: implications for restoration. Marine Ecology Progress Series, 389, 159-170.
Ridge, J T, A B Rodriguez, F J Fodrie, N L Lindquist, M C Brodeur, S E Coleman, J H Grabowski and E J Theuerkauf. 2015. Maximizing oyster-reef growth supports green infrastructure with accelerating sea-level rise. Scientific Reports 5; Article number 14785; doi:10.1038/srep14785
Rodriguez, A B, F J Fodrie, J T Ridge, N L Lindquist, E J Theuerkauf, S E Coleman, J H Grabowski, M C Brodeur, R K Gittman, D A Keller and M D Kenworthy. 2014. Oyster reefs can outpace sea-level rise. Nature Climate Change 4:493-497.
Winslow F. 1889. Report on the Sounds and Estuaries of North Carolina with Reference to Oyster Culture.” United States Coast and Geodetic Survey 10 (1889): 51-136.

The foregoing is illustrative of the present invention, and is not to be construed as limiting thereof. Those skilled in the art will appreciate that various modifications, additions and substitutions are possible, without departing from the scope and spirit of the invention as disclosed in the accompanying claims.

1. An ephemeral substrate material for growing oysters or for modifying the structure of a submerged and/or intertidal bottom, the ephemeral substrate material comprising a biodegradable fiber and a binder comprising a mineral-based hardening agent.

2. The ephemeral substrate material for growing oysters or for modifying the structure of a submerged bottom of claim 1, wherein the binder is cement or is cement-based.

3-5. (canceled)

6. The ephemeral substrate material for growing oysters or for modifying the structure of a submerged bottom of claim 1, wherein the biodegradable fiber is in the form of a strand, netting or cloth.

7. The ephemeral substrate material for growing oysters or for modifying the structure of a submerged bottom of claim 1, wherein the biodegradable fiber is a natural organic fiber.

8-16. (canceled)

17. An artificial oyster growing structure comprising the ephemeral substrate material for growing oysters of claim 1.

18-22. (canceled)

23. The artificial oyster growing structure of claim 17, wherein the structure includes posts, rods or other linear-type architectural elements created by the twisting and/or rolling lengths of binder impregnated cloth of natural organic fibers comprising the ephemeral substrate material.

24. The artificial oyster growing structure of claim 17, wherein the structure includes panels, sheets or other two dimensional architectural elements comprising the ephemeral substrate material.

25. The artificial oyster growing structure of claim 17, wherein the structure includes corrugated panels or sheets, mounds or other three dimensional architectural elements comprising the ephemeral substrate material.

26-37. (canceled)

38. An artificial oyster growing structure array comprising a plurality of artificial oyster growing structures of claim 17.

39. The artificial oyster growing structure array of claim 38, wherein the array is arranged to form letters, numbers, logos and/or shapes.

40. A method of creating a message or advertisement comprising providing an artificial oyster growing structure array or a plurality of artificial oyster growing structure arrays of claim 39.

41. (canceled)

42. A method of providing oysters to a location of low oyster abundance comprising:
seeding an artificial oyster growing structure with juvenile oysters by providing the artificial oyster growing structure of claim 17 in an intertidal zone with high oyster larval settlement rates for a period of time; and
moving the oyster-coated artificial oyster growing substrate to the location of lower oyster abundance following said period of time.

43-47. (canceled)

48. A method of providing oysters to a location of lower oyster abundance comprising:
seeding an artificial oyster growing structure with juvenile oysters by providing the artificial oyster growing structure of claim 17 in a laboratory oyster hatchery for a period of time; and
moving the oyster-coated artificial oyster growing substrate to the location of lower oyster abundance following said period of time.

49. (canceled)

50. A method of rehabilitating an oyster bed comprising:
seeding an artificial oyster growing structure with juvenile oysters by providing the artificial oyster growing substrate of claim 17 in an intertidal zone with high oyster larval settlement rates for a period of time; and
moving the oyster-coated artificial oyster growing substrate to the oyster bed following said period of time.

51-52. (canceled)

53. A method of growing or cultivating oysters comprising:
providing the artificial oyster growing structure of claim 17 in a location where the structure can be seeded with juvenile oysters;
allowing the structure to degrade and shed oysters over time as the oysters grow;
collecting the shed oysters as the structure degrades; and
providing shed oysters into a cultivation process.

54. A method of preparing an artificial oyster growing structure comprising the steps of:
impregnating a biodegradable fiber strand or cloth with a binder;
preparing posts, rods or support stakes, cross-members and flat or corrugated panels from the impregnated biodegradable fiber strand or cloth; and
constructing the artificial oyster growing substrate by providing the posts, rods or support stakes, attaching the cross-members thereto and attaching the flat or corrugated panels to the cross-members.

55. (canceled)

56. The method of claim 54, wherein the posts, rods or support stakes and cross-members are prepared by twisting the biodegradable fiber cloth impregnated with the binder into structures of posts, rods or support stakes, cross-members and other linear structures.

57-62. (canceled)

63. An artificial aquatic bottom overlayment comprising the ephemeral substrate material for modifying the structure of a submerged bottom of claim 1.

64-73. (canceled)

74. A method of controlling shoreline erosion comprising:
providing an artificial oyster growing structure or structures comprising the ephemeral substrate material of claim 1; and
creating an oyster reef using the artificial oyster growing structure or structures to generate a barrier for erosion control.

75-77. (canceled)

78. A method of developing a saltmarsh habitat comprising:
providing an artificial oyster growing structure or structures comprising the ephemeral substrate material of claim 16; and
creating an oyster reef using the artificial oyster growing structure or structures suitable for saltmarsh colonization.

79. (canceled)
